(19) United States
(12) Patent Application Publication
(10) Pub. No.: US 2026/0094230 A1
(43) Pub. Date: Apr. 2, 2026

(54) GRAPHICS PROCESSING

(71) Applicant: Arm Limited, Cambridge (GB)

(72) Inventors: Naveen Kumar Singh, Cambridge (GB); Rafal Stepuch, Cambridge (GB); Frank Klaeboe Langtind, Melhus (NO)

(73) Assignee: Arm Limited, Cambridge (GB)

(21) Appl. No.: 19/343,432

(22) Filed: Sep. 29, 2025

(30) Foreign Application Priority Data
Sep. 30, 2024 (GB) 2414351.3

(51) Int. Cl. G06T 1/20; G06T 11/00

(52) U.S. Cl. CPC G06T 1/20; G06T 11/00; G06T 2210/12

(57) ABSTRACT

A graphics processor executes a graphics processing pipeline in which one or more of a sequence of one or more geometry processing stages of the graphics processing pipeline generate vertex packets for subsequent processing. When the graphics processing pipeline is being executed to render a scene from a plurality of viewpoints, at least some of the geometry processing stages of the sequence of one or more geometry processing stages are performed to generate initial vertex packets comprising vertices for assembled primitives for the scene being rendered. A respective viewpoint vertex packet for each viewpoint of the plurality of viewpoints is then generated for and using each initial vertex packet. The viewpoint vertex packets are then provided to a further stage or stages of the graphics processing pipeline for rendering the scene from the plurality of viewpoints.

### CLAIM OF PRIORITY

This application claims priority to United Kingdom Patent Application No. GB2414351.3 filed Sep. 30, 2024, by Singh, et al., entitled, “GRAPHICS PROCESSING,” which is incorporated by reference herein in its entirety.

### BACKGROUND

The technology described herein relates to graphics processing.

Computer graphics systems typically produce their output, such as frames for display, by processing so-called primitives, which are usually simple polygons such as triangles. Each primitive is normally defined by a set of vertices (e.g. three vertices in the case of triangular primitive).

Typically the set of vertices to be used for a given graphics processing output (e.g. frame for display) will be stored as a set of vertex data defining the vertices (e.g. the relevant attributes for each of the vertices).

While it would be possible simply to store the vertices to be used for each primitive to be generated in turn (such that, in effect, the set of vertices will correspondingly define the primitives to be processed), it is also known to define the primitives separately in terms of a set of indices that reference the vertices in the set of vertex data. This can then avoid, for example, the need to duplicate vertices in the set of vertex data, as a single vertex entry (vertex) in the set of vertices can be referred to multiple times by reusing the relevant index in the set of indices.

Accordingly, in the case of a typical graphics processing pipeline, the initially provided data for an output to be generated will, inter alia, comprise a set of vertices to be used and processed for generating the output, and a set (sequence) of indices referencing the set of vertices (to, in effect, define how the vertices will be used to form a set of primitives to be processed when generating the output).

Each vertex will have associated with it a set of data (such as position, colour, texture and other attributes) representing the vertex. This “vertex” data is then used when processing a primitive that includes the vertex in order to generate the desired output of the graphics processing system.

Once the vertices and sets of vertex indices for an output have been generated, they can be processed by a graphics processor to generate the desired graphics processing output (render target), such as a frame for display.

This will comprise, inter alia, “assembling” primitives using the vertices based on the set (sequence) of vertex indices, and then processing the so-assembled primitives.

The primitive processing may involve, for example, determining which sampling points of an array of sampling points associated with the output area to be processed are covered by a primitive, and then determining the appearance each sampling point should have (e.g. in terms of its colour, etc.) to represent the primitive at that sampling point. These processes are commonly referred to as rasterising and rendering, respectively.

The rasterising and rendering processes use the vertex attributes associated with the vertices of the primitive that is being processed. To facilitate this operation at least some of the attributes of the vertices defined for the given graphics processing output are usually subjected to an initial so-called “vertex shading” (vertex processing) operation, before the primitives are, e.g. rasterised and rendered. This “vertex shading” operation operates to transform the attributes for a vertex into a desired form for the subsequent graphics processing operation(s). This may comprise, for example, transforming vertex position attributes from the model or user space that they are initially defined in, to the screen space that the output of the graphics processing is to be displayed in.

A graphics processing pipeline executed by a graphics processor will typically therefore include a vertex processing stage (a vertex shader) that executes vertex processing (shading) computations on initial vertex attribute values defined for the vertices so as to generate a desired set of output vertex attributes (i.e. appropriately “shaded” attributes) for use in the subsequent processing stages of the graphics processing pipeline.

There will also be an appropriate “primitive assembly” operation that “assembles” the primitives that are to be processed by the graphics processing pipeline from the provided indices and vertices, e.g. in accordance with a defined primitive type or types that are to be assembled using the provided indices and vertices.

The so-assembled primitives will then be processed, e.g. rasterised and rendered.

FIG. 1 illustrates this graphics processing sequence when generating an output.

As shown in FIG. 1, for an output to be generated, a set of scene data 11, including, inter alia, a set of vertices, and a set of indices defining primitives to be processed for the output and referencing the set of vertices, is provided.

The vertices then undergo appropriate vertex processing (shading) 12, e.g. to transform the positions for the vertices from “model” space to “screen” space.

There is then a primitive assembly stage 13 which takes the indices and the processed vertices and assembles primitives for processing using the indices and the vertices, e.g. in accordance with information indicating how the primitives are to be assembled using the indices (e.g. whether primitives in the form of simple triangles, triangle strips, or triangle fans, etc., should be generated for processing).

The assembled primitives are then rasterised 14 to generate appropriate graphics fragments for processing, and the fragments generated by the rasteriser are then processed appropriately (rendered) 15 to provide the final output, e.g. image 16.

The Applicants believe that there remains scope for improvements to such graphics processing operations.

### BRIEF DESCRIPTION OF THE DRAWINGS

Embodiments of the technology described herein will now be described by way of example only and with reference to the accompanying drawings, in which:

FIG. 1 shows an exemplary sequence of graphics processing;

FIG. 2 shows an exemplary data processing system in which the technology described herein may be implemented;

FIG. 3 shows schematically a graphics processor that may be operated in accordance with the technology described herein;

FIG. 4 shows certain parts of the operation of the graphics processor of FIG. 3 in an embodiment;

FIG. 5 shows certain parts of the operation shown in FIG. 4 in more detail;

FIG. 6 is a flowchart showing the generation of respective viewpoint vertex packets in an embodiment of the technology described herein.

FIG. 7 shows certain parts of the operation of the graphics processor of FIG. 3 operating in a multi-view rendering configuration in an embodiment;

FIGS. 8A and 8B show example vertex packets for embodiments of the technology described herein;

FIG. 9 shows how respective viewpoint vertex packets can be generated from an initial vertex packet in an embodiment of the technology described herein; and

FIG. 10 shows further parts of the operation of the graphics processor of FIGS. 3 and 7 in an embodiment.

Like reference numerals are used for like features in the Figures, where appropriate.

### DETAILED DESCRIPTION

A first embodiment of the technology described herein comprises a method of operating a graphics processor that executes a graphics processing pipeline to generate an output, the graphics processing pipeline being executed comprising:
a sequence of one or more geometry processing stages to perform geometry processing, one or more of the sequence of one or more geometry processing stages generating vertex packets for subsequent processing, the vertex packets comprising vertices for assembled primitives; and
a rendering stage for rendering an output being generated;
the method comprising:
when executing the graphics processing pipeline to render a scene from a plurality of viewpoints:
performing at least some of the geometry processing stages of the sequence of one or more geometry processing stages of the graphics processing pipeline to generate an initial vertex packet comprising vertices for assembled primitives for the scene being rendered; and
generating, for each viewpoint of the plurality of viewpoints, a respective viewpoint vertex packet using the initial vertex packet; and
providing the viewpoint vertex packets generated for the plurality of viewpoints to a further stage or stages of the graphics processing pipeline being executed for rendering the scene from the plurality of viewpoints.

A second embodiment of the technology described herein comprises a graphics processor operable to execute a graphics processing pipeline to generate an output, the graphics processor comprising processing circuits configured to execute a processing pipeline comprising:
a sequence of one or more geometry processing stages to perform geometry processing, one or more of the sequence of one or more geometry processing stages configured to generate vertex packets for subsequent processing, the vertex packets comprising vertices for assembled primitives; and
a rendering stage for rendering an output being generated;
the graphics processor further comprising:
a processing circuit configured to, when the graphics processor is executing the graphics processing pipeline to render a scene from a plurality of viewpoints:
   generate, using an initial vertex packet generated by performing at least some of the geometry processing stages of the sequence of one or more geometry processing stages of the graphics processing pipeline and comprising vertices for assembled primitives for the scene being rendered, a respective viewpoint vertex packet for each viewpoint of the plurality of viewpoints; and
   provide the viewpoint vertex packets generated for the plurality of viewpoints to a further stage or stages of the graphics processing pipeline being executed for rendering the scene from the plurality of viewpoints.

The technology described herein relates to rendering a scene from a plurality of viewpoints, i.e. “multi-view” rendering. Multi-view rendering may, e.g., be performed in the case of virtual reality (VR) and/or augmented reality (AR) display, where a scene is generally rendered from two viewpoints, e.g. for stereoscopic rendering.

When rendering a scene from different viewpoints, scene data may be needed to be processed differently for each viewpoint (for example, based on the different positions of the scene data with respect to the different viewpoints).

In the technology described herein, geometry processing stages of a graphics processing pipeline operate to generate “vertex packets” containing vertices associated with assembled primitives. When a scene is being rendered from multiple viewpoints, an initially generated vertex packet is used to generate respective vertex packets for each viewpoint of the plurality of viewpoints being rendered (so that each viewpoint has associated with it a respective viewpoint vertex packet that can be processed by the graphics processing pipeline for rendering the scene for the viewpoint in question).

Thus, for a given vertex packet, the vertex packet to be used for each viewpoint is generated from an “initial” vertex packet generated by the geometry processing stages.

As will be discussed further below, this will be, and is in an embodiment, done for each “initial” vertex packet that is generated for a scene that is to undergo multi-view rendering.

The Applicants have recognised in this regard that generating vertex packets for the viewpoints when performing multi-view rendering in this manner facilitates reducing the memory bandwidth required when generating vertex packets when performing multi-view rendering (compared to, for example, alternative arrangements for producing vertex data when performing multi-view rendering).

For instance, in the technology described herein, a set of (scene) data may only need to be accessed once to generate (all) the vertex packets for each viewpoint being rendered (rather than, for example, accessing the (scene) data separately for each viewpoint).

Further, by generating the respective vertex packets for each viewpoint being rendered in the manner according to the technology described herein, each of the respective viewpoint vertex packets will, and in an embodiment does, relate to (only) one viewpoint, which can enhance memory efficiency, and in particular cache efficiency, when rendering a scene from a plurality of viewpoints.

The technology described herein can thus provide an increase in memory efficiency and memory bandwidth when performing multi-view rendering.

In the technology described herein, at least some of the geometry processing stages of the sequence of one or more geometry processing stages of the graphics processing pipeline operate to generate vertex packets. As will be discussed further below, typically and in an embodiment, a sequence of plural vertex packets will be generated for a scene to be rendered.

The vertex packet(s) are generated to comprise vertices for assembled primitives.

A (and each) vertex packet in an embodiment comprises vertex indices for assembled primitives (the vertex indices indicating respective vertices for assembled primitives).

A vertex packet thus in an embodiment comprises a set of one or more (and in an embodiment of plural) vertices, in an embodiment in the form of vertex indices (the vertex indices indicating vertices of the scene that are for assembled primitives), for assembled primitives.

In an embodiment, when initially generated (and prior to any further processing), the vertex packets (only) comprise vertex indices for assembled primitives (in an embodiment, as well as other information for identifying the vertex packet (as discussed further below)).

A vertex packet may comprise any suitable and desired (plural) number of vertices (vertex indices).

In embodiments, the vertex packets are in an embodiment of fixed capacity. In this respect, a (and each) vertex packet can in an embodiment include (and where possible includes) up to a threshold capacity.

The threshold capacity can be any suitable and desired capacity, and can be set in any suitable and desired manner.

In an embodiment, the threshold capacity is a (maximum) number of vertices and/or primitives.

The threshold number of vertices and/or primitives should, and in an embodiment does, accordingly correspond to a maximum permitted number of vertices and/or primitives that may be allocated to (included in) a vertex packet.

In embodiments, the capacity of a vertex packet is a (total) maximum number of vertices that the vertex packet can (and in an embodiment, is permitted to) comprise. In other embodiments, the capacity of a vertex packet is a (total) maximum number of primitives that the vertex packet can (and in an embodiment, is permitted to) comprise vertices for.

In an embodiment, each vertex packet can comprise up to the same threshold (permitted maximum) number of vertices and/or primitives, such as, for example, 16, 32 or 64 vertices/primitives.

In an embodiment, vertex packets comprise, wherever possible, the threshold number of vertices and/or primitives.

It may also be the case that some vertex packets comprise less than the threshold number of vertices and/or primitives. For instance, it may be the case that for some vertex packets, there are not enough vertices available to be included in that vertex packet. This will be particularly the case for any “final” vertex packets being generated in a sequence of vertex packets (for example, this may occur when generating (the) final vertex packets for a given draw call).

In an embodiment, a set of vertices to be used for primitives to be processed when generating the output, each vertex having associated with it a set of one or more vertex attributes, together with a set of vertex indices referencing vertices in the set of vertices, and primitive configuration information indicating how the vertex indices are to be assembled into primitives for processing when generating the output are provided to the graphics processing pipeline (and in an embodiment to one or more of the geometry processing stages), and then used for (when) generating the vertex packets.

In an embodiment, the set of vertices, set of vertex indices, and primitive configuration information can allow one or more of the geometry processing stages to assemble a sequence of one or more primitives present in the scene so that these primitives can be suitably processed when rendering the scene.

(When rendering a scene from a plurality of viewpoints, regardless of the viewpoint being rendered, the scene will generally contain the same scene data (although, the manner in which the scene data is processed for each viewpoint may be different). Thus, the set of vertices, set of vertex indices, and the sequence of one or more primitives present in the scene will typically, and is in an embodiment, applicable to each viewpoint of the plurality of viewpoints, as this data is a part of the scene data and is generally not specific to any one of the viewpoints being rendered.)

The set of vertices to be used for primitives to be processed when generating the output, the set of vertex indices referencing vertices in the set of vertices, and the primitive configuration information indicating how the vertex indices are to be assembled into primitives for processing when generating the output, may be provided in any suitable and desired manner. They may, for example, be provided by an application that requires the graphics processing in question, and/or be generated and then provided by a driver for the graphics processor, e.g., and in an embodiment, in response to commands and data received from an application that requires graphics processing.

The vertices, vertex indices and primitive configuration information can be made available to the graphics processor (and the graphics processing pipeline) in any suitable and desired manner. For example, and in an embodiment, the vertices and vertex indices at least may be stored (e.g., and in an embodiment, as appropriate arrays) in memory from where they can then be fetched by the graphics processor, and in an embodiment stages of the graphics processing pipeline, for use. The primitive configuration information may equally be stored in memory for use by the graphics processor. It may, for example, be provided in the form of a descriptor associated with and for the output to be generated.

The sets of vertices and vertex indices that are being processed can be any desired and suitable sets of vertices and vertex indices to be processed when generating an output. Thus, the sets of vertices and vertex indices may comprise (and in one embodiment do comprise) the entire set of vertices and the entire set of vertex indices defined for a given graphics processing output, such as for a frame to be displayed. They may also comprise a set of vertices and set of vertex indices that is defined for less than the entire output, such as a set of vertices and a set of vertex indices defined for a given draw call, and/or for a tile to be generated (in a tile-based graphics processor and graphics processing pipeline). In an embodiment, the set of vertices and set of vertex indices are a set of vertices and a set of vertex indices defined for a draw call.

Correspondingly, the output that is being generated may comprise an entire (complete), e.g. frame, or only part of an overall output (e.g. frame), such as a draw call, or a (rendering) tile for each viewpoint of the plurality of viewpoints being rendered (and for, e.g., the draw call in question).

Where the sets of vertices and vertex indices are less than the entire sets of vertices and vertex indices defined for a given output, then in an embodiment the operation in the manner of the technology described herein is repeated for each set of vertices and vertex indices (e.g., and in an embodiment, for each draw call and/or tile) for the output. Correspondingly, the process of the technology described herein is in an embodiment repeated for plural, and in an embodiment for each, output to be generated, e.g. for successive frames in a sequence of output frames, and/or for each tile making up an overall output, e.g. frame.

Each vertex index in the set of vertex indices for the output to be generated will identify (index) a corresponding vertex that is provided in the set of vertices for the output. Thus, the vertices will each be identifiable by a corresponding index that (uniquely) identifies the vertex in the set of vertices. In an embodiment the indices are the “input” indices for the vertices as provided (e.g. by the application/driver) prior to any processing of the vertices.

The same vertex index may appear more than once in the set of vertex indices for the output, and/or it may be the case that some vertices in the set of vertices for the output will not in fact be included in the set of indices for the output.

The set of vertex indices for the output to be generated is in an embodiment provided to a primitive assembly process (and circuit) as an appropriate sequence of vertex indices, in the order in which the indices are to be used for primitives for the output.

The primitive configuration information that is provided for the output can be any suitable and desired information that is indicative of, and that defines, how the vertex indices are to be used for (configured into) the primitives for processing for the output. In an embodiment, the primitive configuration information indicates the type of primitives to be assembled using the sequence of vertex indices, i.e. whether the primitives should, for example, be in the form of triangles, triangle strips, triangle fans, or other forms of configuration (such as lines or points).

As discussed above, (one or more of) the geometry processing stages in an embodiment operate to assemble a sequence of one or more primitives present in the scene so that these primitives can be suitably processed when rendering. In an embodiment, the primitives are assembled from the primitive configuration information, the set of vertices, and set of vertex indices, in any suitable and desired manner. In an embodiment, the primitives are assembled in this manner prior to the vertex packets being generated.

By assembling the primitives prior to the generation of the vertex packets, the assembled primitives can remain defined with respect to vertices in model or user space that they are initially defined in, for example, as opposed to vertices defined with respect to screen space of the output (e.g. any one of the rendered outputs for one of the particular viewpoints being rendered).

As such, the technology described herein in an embodiment comprises assembling a sequence of one or more of primitives to be processed when generating the output from the set of vertex indices provided for the output based on the primitive configuration information provided for the output, each assembled primitive of the sequence of assembled primitives comprising an identifier for the primitive and a set of one or more vertex indices for the primitive.

Thus, the one or more of the sequence of one or more geometry processing stages are operable, and in an embodiment configured to, assemble a sequence of one or more of primitives to be processed when generating the output from a set of vertex indices provided for the output based on primitive configuration information provided for the output, each assembled primitive of the sequence of assembled primitives comprising an identifier for the primitive and a set of one or more vertex indices for the primitive. In an embodiment, this process is performed prior to the vertex packet generating process, and in an embodiment, the output of this process is provided to the vertex packet generating process.

In an embodiment, the one or more stages of the sequence of one or more geometry processing stages comprise a primitive assembly stage configured to operate in this manner.

In an embodiment, the primitive assembly process (and the appropriate one or more geometry processing stages are configured to) should, and in an embodiment does, fetch vertex indices from a set (array) of vertex indices in their (desired) sequence order, and “assemble” respective sub-sequences of the fetched vertex indices corresponding to primitives based on the primitive configuration information.

Correspondingly, the primitive assembly process in an embodiment includes a step of fetching vertex indices from a set (array) of vertices and outputting the vertices as a stream of vertices in the (desired) vertex index order to the primitive assembly process for assembling into primitives.

Correspondingly, the graphics processor, and in an embodiment the primitive assembly stage (circuit), in an embodiment includes an index fetcher (an index fetching circuit) that is operable to read and fetch indices from a (stored) set of indices (from an index array) and output a sequence (stream) of indices for assembling into primitives.

For example, where the primitive configuration indication indicates that primitives in the form of triangles should be generated, the primitive assembly process and stage will output respective sets of three successive indices from the sequence of vertex indices (thereby providing a sequence of triangles for processing). For triangle strips, again the sequence of assembled primitives will comprise respective sets of three indices from the sequence of vertex indices, but in that case each successive triangle will reuse the last two indexes in the previous triangle (and the index order will, e.g., be reversed)). Other primitive types will be configured correspondingly.

The primitive assembly operation (stage) is in an embodiment configured to output “complete” primitives only (i.e. sequences of the vertex indices for “complete” primitives only). Thus, where only an “incomplete” or “degenerate” primitive can be assembled from a given set of indices from the index sequence, in an embodiment no primitive is output by the primitive assembly process/circuit.

Thus any “faulty” (incomplete or degenerate) primitives are in an embodiment “removed” at the primitive assembly stage, thereby avoiding performing vertex (attribute) fetching and processing for vertices that are only included in degenerate or incomplete primitives.

Correspondingly, the primitive assembly operation (stage) is in an embodiment able to recognise and discard any “faulty” (incomplete or degenerate) primitives, such that it will then output only complete primitives for further processing. This may be done, for example, and in an embodiment, in accordance with the graphics API in question.

In an embodiment, the primitive assembly operation/circuit is configured to and operable to output “simple” primitives, such as triangles, lines or points. In an embodiment the primitive assembly operation/circuit is operable to convert more complex primitives (such as line strips, line links, triangle strips, triangle fans, quads, quad strips, lines with adjacency, line strips with adjacency, triangles with adjacency and triangle strips with adjacency) into simpler primitives, such as, and in an embodiment, one or more of: triangles, lines or points (which “simpler” primitives are then output by the primitive assembly process/circuit for further processing).

The output of the primitive assembly process (stage) is in an embodiment a sequence of (plural) primitives to be processed, with each primitive that is output from the primitive assembly process comprising an identifier for the primitive and a sequence of vertex indices for the primitive.

The identifier for each output primitive can be any suitable and desired identifier that can be used to uniquely identify the primitive within, e.g., and in an embodiment, the set of primitives in question (e.g. the set of primitives for the output in question). In one embodiment, the primitives are simply numbered in sequence (by the primitive assembly process/circuit) with the sequence number for each primitive acting as its identifier. Other arrangements would, of course, be possible.

In an embodiment, the primitive identifiers assigned by the primitive assembly process (stage) may be overridden by a later identifier that is generated for and/or assigned to the primitive in question, for example as a result of vertex (attribute) processing and/or the generation of the respective viewpoint vertex packets. In an embodiment, the primitives output by the primitive assembly process (circuit) may also have associated with them a flag to indicate whether the identifier allocated to the primitive by the primitive assembly process can be overridden by another (e.g. a later) primitive identifier or not.

The primitive assembly process (circuit) can also output other information (e.g. state) for a (and each) primitive, if desired. (However, at this stage the primitive assembly process (circuit) in an embodiment does not output any vertex attributes in association with the assembled primitives.)

Thus, in an embodiment, the primitive assembly process comprises (and a primitive assembly stage (circuit) is correspondingly configured to) fetching indices from a sequence of vertex indices defined for the output being generated in the vertex index sequence order, organising (e.g. dividing) the fetched vertex indices into respective sub-sequences of vertex indices corresponding to complete primitives based on primitive configuration information, and outputting each respective sub-sequence of vertex indices corresponding to a complete primitive as an assembled primitive in association with, at least, an identifier for the primitive (which in an embodiment is a respective sequence number for the primitive).

From the above description, it will be appreciated that in an embodiment of the technology described herein, one or more of the sequence of one or more geometry processing stages (e.g. a primitive assembly stage) generate (a sequence of) assembled primitives (in an embodiment using a set of vertices to be used for primitives to be processed when generating the output, each vertex having associated with it a set of one or more vertex attributes, together with a set of vertex indices referencing vertices in the set of vertices and primitive configuration information indicating how the vertex indices are to be assembled into primitives for processing when generating the output, the set of vertices, set of vertex indices and primitive configuration information in an embodiment being provided to the graphics processing pipeline), the (sequence of) assembled primitives comprising a sequence of vertices (vertex indices) for assembled primitives (and in an embodiment comprising identifiers for the primitives as well as a sequence of vertex indices for the primitives).

The vertex packets can be generated using vertices for assembled primitives in any suitable and desired manner.

In an embodiment, the sequence of vertices for assembled primitives is provided to the one or more of the sequence of one or more geometry processing stages that generate vertex packets, for generating the vertex packets.

In an embodiment, a vertex packet is generated by allocating vertices for assembled primitives, in an embodiment from a sequence of vertices, to the vertex packet. Vertices for assembled primitives can be allocated to vertex packets in any suitable and desired manner.

In an embodiment, vertices of assembled primitives are allocated to a vertex packet in turn, one after another, until the threshold capacity of the vertex packet is reached for the vertex packet in question (e.g. until the threshold number of vertices and/or primitives is reached for the packet in question), with a new vertex packet then being started thereafter for any further vertices of assembled primitives. In an embodiment, vertices for assembled primitives are allocated to vertex packets based on (according to) the order in which they appear in the sequence of assembled primitives (i.e. according to the order in which the vertices appear in the sequence of vertices for assembled primitives).

Thus, in an embodiment, the vertex packet generating process is configured to allocate vertices for assembled primitives to a vertex packet until the threshold number of vertices and/or primitives have been allocated to the vertex packet, and in an embodiment once the threshold and/or primitives number of vertices have been allocated to the initial vertex packet, thereafter start a new vertex packet (and allocate any further vertices for assembled primitives to the new vertex packet) (again until that vertex packet is “full”) (and so on). (Correspondingly, once the threshold number of vertices have been added to a vertex packet, (in an embodiment) no further vertices are added to the vertex packet.)

It will be appreciated in this regard that whilst vertices are in an embodiment allocated to vertex packets until the threshold number of vertices and/or primitives has been allocated to the vertex packet (i.e. the vertex packet is “full”), it may be the case that for the final (end) vertex packet that is being generated for a given output in the manner of the technology described herein, there will not be enough vertices/primitives (remaining in the sequence of vertices, e.g. for a draw call) to be allocated to that final vertex packet for it to reach its threshold capacity (the threshold number of vertices and/or primitives). Thus, in embodiments, it is permissible to generate a packet with fewer than the threshold number of vertices and/or primitives (i.e. below its threshold capacity), in an embodiment when there are fewer vertices remaining in, and/or primitives for, the sequence of vertices to be processed than the threshold number of vertices/primitives for a “full” packet.

In an embodiment, therefore, when generating a vertex packet, vertices (in an embodiment vertex indices) for assembled primitives from a sequence of vertices for assembled primitives, are allocated to a vertex packet, in an embodiment, until the vertex packet reaches its threshold capacity (in an embodiment, a threshold number of vertex indices and/or a threshold number of primitives) or until a final vertex for an assembled primitive has been allocated to the vertex packet (e.g. when there are no more vertices in the sequence of vertices for assembled primitives to be allocated to the vertex packet).

It would be possible simply to allocate vertices for assembled primitives to vertex packets as the primitives are assembled, such that the vertices are simply allocated to vertex packets as they appear in assembled primitives.

However, in an embodiment, the allocating of vertices of assembled primitives to a vertex packet is configured so as to try to avoid duplication of vertices at least within the same vertex packet.

Avoiding the duplication of vertices between vertex packets can be done in any suitable and desire manner.

To facilitate this operation, it is accordingly and correspondingly in an embodiment tracked which vertices have been included in a vertex packet. Thus, in an embodiment, the generation of vertex packets comprises (and the vertex packet generating process is correspondingly configured to) keeping track of the vertices that have been allocated to a vertex packet, and, in an embodiment, using that tracking to determine whether a vertex (potentially) to be allocated to a vertex packet is already present in a vertex packet or not.

Thus, in an embodiment, the generating of a vertex packet further comprises associating with the vertex packet, tracking information indicative of the vertices that have been allocated to the vertex packet.

The tracking information to (try to) avoid duplication of vertices in vertex packets can take any suitable and desired form and be used in any suitable and desired manner.

In an embodiment, the tracking uses the vertex indices (the indices of the vertices) (that have been included in the assembled primitives), such that, for example and in an embodiment, a record of the indices of all the vertices that have been included in a vertex packet is maintained for a vertex packet, and then the index of a new vertex to (potentially) be allocated to a vertex packet is compared to the record of the vertex indices already present in a vertex packet, to determine whether the vertex is already present in a vertex packet or not.

In an embodiment, it is considered whether a vertex is within a “tracking window” of vertex packets to avoid the duplication of that vertex within the tracking window of vertex packets.

In an embodiment, a queue of plural vertex packets is maintained while the vertices for assembled primitives are being allocated to vertex packets, with the packets in the queue being generated in turn. In an embodiment the queue comprises a particular, in an embodiment selected, in an embodiment predetermined maximum number of packets (for example corresponding to the “tracking window”, e.g. four packets). A (any) determination of whether a vertex has already been allocated to a vertex packet in an embodiment considers all the vertex packets in the queue.

Other arrangements would, of course, be possible.

As discussed above, the vertex packets are in an embodiment of fixed size. The number of vertices in the sequence of vertices for assembled primitives and/or the number of assembled primitives may thus exceed the threshold capacity number of a single vertex packet.

Accordingly, the vertex packet generating process may, and typically will, generate a sequence of plural vertex packets. In this case, each of the vertex packets in the sequence of vertex packets is in an embodiment associated with an appropriate identifier that uniquely identifies the vertex packet within the sequence of vertex packets.

The technology described herein relates in particular to the performing of multi-view rendering. In this case, an initial vertex packet is generated and then used to generate respective, corresponding vertex packets to be processed for each viewpoint.

An (and each) initial vertex packet, in this regard, can be generated in any suitable and desired manner. In an embodiment, an (and each) initial vertex packet is generated in the manner described above.

Correspondingly, in an embodiment, a sequence of initial vertex packets is generated (as described above), and each of the initial vertex packets in the sequence of initial vertex packets is in an embodiment then used to generate a corresponding set of viewpoint vertex packets corresponding to the initial vertex packet in question, so that each viewpoint of the plurality of viewpoints has associated with it a corresponding sequence of respective viewpoint vertex packets.

The respective viewpoint vertex packets can be generated using an initial vertex packet in any suitable and desired manner.

In an embodiment, the viewpoint vertex packets have the same form as the vertex packets described above.

In an embodiment, the respective viewpoint vertex packets are generated to have vertices corresponding to (the same as) those of the initial vertex packet used to generated the respective viewpoint vertex packets.

In an embodiment, the vertices of the respective viewpoint vertex packets, at least initially (e.g. prior to any vertex attribute processing of the respective viewpoint vertex packets), correspond to (e.g. are the same as (or are duplicates of)) the vertices of the initial vertex packet used to generate the respective viewpoint vertex packets.

In an embodiment, the respective viewpoint vertex packets comprise the same vertices (vertex indices) as the initial vertex packet used to generate them. In this respect, the respective viewpoint vertex packets in an embodiment comprise (all) the vertices for assembled of the initial vertex packet used to generate the respective viewpoint vertex packets.

The respective viewpoint vertex packets, when generated (and prior to any vertex attribute shading of those packets) therefore (in an embodiment) comprise vertices for assembled primitives (in an embodiment in the form of vertex indices), the vertices corresponding to all of (the same as all of) the vertices (vertex indices) of the initial vertex packet used to generated the respective viewpoint vertex packets.

So that it can be identified which viewpoints the respective viewpoint vertex packets are for, the respective viewpoint vertex packets are also in an embodiment associated with a viewpoint identifier that (uniquely) indicates the viewpoint of the plurality of viewpoints the respective viewpoint vertex packet relates to. The respective viewpoint vertex packets can be associated with an appropriate viewpoint identifier in any suitable and desired manner, and the viewpoint identifier can take any suitable and desired form.

In an embodiment, each viewpoint has a corresponding viewpoint identifier, and the viewpoint vertex packets are associated with the identifier for the viewpoint that they relate to (are to be used for).

In an embodiment, the viewpoint identifier is stored as metadata for the respective viewpoint vertex packets, e.g. in a header portion of the respective viewpoint vertex packet.

The viewpoint identifier is in an embodiment used by later stages of the graphics processing pipeline, e.g. the geometry processing stages and the rendering stages, to configure the processing that those stages perform for the particular viewpoint that the packets are for.

So that is can be tracked which vertices are in each respective viewpoint vertex packet, in an embodiment, the respective viewpoint vertex packets also comprise the vertex tracking information corresponding to that of the initial vertex packet used to generate the respective viewpoint vertex packet.

As described above, there can be in some cases generated a plural sequence of vertex packets for a given output to be rendered. In a corresponding manner, a sequence of plural initial vertex packets may be generated. In an embodiment, each of the initial vertex packets in the sequence of initial vertex packets is then used to generate respective viewpoint vertex packets, such that, in an embodiment, each respective viewpoint will have associated with it a corresponding plural sequence of respective viewpoint vertex packets.

In the case where a sequence of initial vertex packets has been generated, and where each of those initial vertex packets is used to generate corresponding respective viewpoint vertex packets, each respective viewpoint vertex packet in an embodiment is associated with an appropriate identifier that (uniquely) identifies the viewpoint vertex packet within the sequence of viewpoint vertex packets being generated.

In an embodiment, the “sequence” identifiers associated with the respective viewpoint vertex packets are the same as those associated with the initial vertex packets used to generate them (so that they are identified within their respective sequences correspondingly).

As discussed above, the Applicants have recognised that by generating an initial vertex packet, and using that vertex packet to generate the vertex packets for each of the viewpoints, the (required) scene data may only need to be processed once to generate (all) the vertex packets (i.e. to generate the initial vertex packet(s)).

Accordingly, in an embodiment of the technology described herein, generating, for each viewpoint of the plurality of viewpoints, a respective viewpoint vertex packet using the initial vertex packet comprises:
generating, for each viewpoint of the plurality of viewpoints, respective viewpoint vertex packet comprising vertices corresponding to the vertices of the initial vertex packet; and in an embodiment further comprises:
associating each respective viewpoint vertex packet with an appropriate viewpoint identifier that (uniquely) identifies which of the plurality of viewpoints the respective viewpoint vertex packet is for.

The respective viewpoint vertex packets for each viewpoint of the plurality of viewpoints can be generated using an initial vertex packet in any suitable and appropriate manner.

In an embodiment of the technology described herein, there is a viewpoint vertex packet generating process (circuit) that generates (the circuit being configured to generate) a respective viewpoint vertex packet for each of the viewpoints being rendered using an initial vertex packet.

In an embodiment of the technology described herein, respective viewpoint vertex packets are generated as a result of sending the initial vertex packet for processing, and in particular for vertex attribute processing (vertex shading).

In graphics processing it may be, and typically can be, the case that at least some of the initially defined attribute values for a vertex need to be processed in some way before they are used by the graphics processor when generating an output. For example, positions defined for a vertex may need to be transformed from the (e.g. model) space that they are initially defined in, into the (e.g. screen) space that the output will be generated for (and with respect to). This processing of vertex attributes may typically be referred to as “vertex shading”.

In this respect, vertex packets can be provided to, and subsequently processed by, a vertex attribute processing stage(s) of the graphics processing pipeline, so that the vertices of the packets can be shaded.

As described above, when the respective viewpoint vertex packets are initially generated, and prior to any vertex attribute processing, they in an embodiment comprise the same vertex indices as the initial vertex packet used to generate them.

Given that these vertices of the respective viewpoint packets will generally have to be shaded for rendering the scene for the plurality of viewpoints, the Applicants have correspondingly recognised that the respective viewpoint vertex packets can be generated as and when an initial vertex packet is sent for vertex attribute processing (vertex shading). In an embodiment, the respective viewpoint vertex packets are generated using the initial vertex packet in response to (and as a result of) the initial vertex packet being sent for vertex attribute processing.

Thus, in an embodiment of the technology described herein, generating, for each viewpoint of the plurality of viewpoints, a respective viewpoint vertex packet using an initial vertex packet comprises:
sending the initial vertex packet for vertex attribute processing a number of times corresponding to the number of viewpoints of the plurality of viewpoints (with the respective vertex attribute processed (vertex shaded) initial vertex packet for a viewpoint then forming (being) the viewpoint vertex packet for that viewpoint).

By sending the (same) initial vertex packet for vertex attribute processing (vertex shading) a number of times corresponding to the number of viewpoints of the plurality of viewpoints, a number of (identical) vertex packets corresponding to the number of viewpoints will sent for shading.

Each of these vertex packets sent for vertex attribute processing can therefore effectively comprise the same vertices, and are in an embodiment associated with the same tracking data and appropriate vertex packet identifier.

To identify which vertex packet sent for vertex attribute processing is for which viewpoint of the plurality of viewpoints, each vertex packet sent for vertex attribute processing is in an embodiment associated an appropriate viewpoint identifier indicating which viewpoint of the plurality of viewpoints the vertex packet is for (e.g. as described above).

In an embodiment, the initial vertex packet is sent iteratively for vertex shading, and the initial vertex packet is stopped being sent for vertex shading when it has been sent a number of times corresponding to (the same as) the number of viewpoints in the plurality of viewpoints.

In this respect, the viewpoint identifier can in an embodiment be used to control the sending of the initial vertex packet. For instance, in an embodiment, each time an initial vertex packet is sent for vertex shading, it is determined whether the viewpoint identifier it is associated is for the final viewpoint of the plurality of viewpoints.

Of course, other arrangements are suitable. For instance, the number of times the initial vertex packet has been sent for vertex shading can be suitably tracked, e.g. using a counter, and the sending of the initial vertex packet for vertex shading can be stopped once the packet has been sent a number of times equal to the number of viewpoints in the plurality of viewpoints.

Where the initial vertex packet is sent iteratively for vertex shading, the generation of a particular one of the respective viewpoint vertex packets can be triggered by an (immediately) preceding respective viewpoint vertex packet having been generated (i.e. by the completion of the previous iteration of the sending of the initial vertex packet having been completed).

In an embodiment where there is a sequence of initial vertex packets generated, the respective viewpoint vertex packets for a particular one of the initial vertex packets in a sequence of initial vertex packets are in an embodiment generated when (after) (all) the respective viewpoint vertex packets for an (immediately) preceding one of the initial vertex packets of the sequence of initial vertex packets have been generated.

Other arrangements for generating the respective viewpoint vertex packets from an initial vertex packet are of course possible.

For example, the respective viewpoint packets can be generated prior to the (initial) vertex packet being sent for vertex attribute processing.

Thus, in another embodiment, the initial vertex packet (the vertices of the initial vertex packet) is duplicated into a number of vertex packets to give a set of vertex packets corresponding to the number of viewpoints in the plurality of viewpoints, and each of those vertex packets is associated with a particular one of the viewpoints. In this embodiment, the initial vertex packet is in an embodiment discarded when the respective viewpoint vertex packets have been generated (or it could be used as the viewpoint vertex packet for one of the viewpoints).

In this case, when generating, for each viewpoint of the plurality of viewpoints, a respective viewpoint vertex packet using an initial vertex packet, in an embodiment the vertices of the initial vertex packet are duplicated into a number of vertex packets corresponding to the number of viewpoints of the plurality of viewpoints.

In another embodiment, the initial vertex packet is associated with a particular one of the viewpoints of the plurality of viewpoints, and its vertices are duplicated into other vertex packets, one for each remaining viewpoint of the plurality of viewpoints (i.e. one for each viewpoint other than that to which the initial vertex packet is assigned).

Thus, in an embodiment, when generating, for each viewpoint of the plurality of viewpoints, a respective viewpoint vertex packet using an initial vertex packet, the initial vertex packet is associated with a particular one of the viewpoints of the plurality of viewpoints, and the vertices of the initial vertex packet are duplicated into a number of vertex packets corresponding to the number of remaining viewpoints of the plurality of viewpoints.

In this case, the viewpoint vertex packet generating process (circuit) in an embodiment assigns the initial vertex packet to a particular one of the viewpoints of the plurality of viewpoints being rendered, and generates (additional) respective viewpoint vertex packets for the viewpoints of the plurality of viewpoints other than the particular one of the viewpoints, having vertices corresponding to the initial vertex packet (assigned to the particular one of the viewpoints).

In either of these embodiments, the respective viewpoint vertex packets are in an embodiment appropriately associated with the tracking information, and identifiers, as discussed above.

In these embodiments, where the respective viewpoint vertex packets are generated prior to the (initial) vertex packet having been sent for vertex attribute processing, once the respective viewpoint vertex packets are generated, they are in an embodiment sent for vertex attribute processing. This can be done in any suitable and desired manner.

Other arrangements for generating the respective viewpoint vertex packets using an initial vertex packet are of course possible.

The vertex (attribute) processing (vertex shading) (whether of an initial vertex packet to generate a viewpoint vertex packet, or of an already generated viewpoint vertex packet) is in an embodiment triggered on a vertex packet by vertex packet basis, and only for vertices that are allocated to respective initial/viewpoint vertex packets.

Correspondingly, in an embodiment, no vertex attribute processing is performed prior to the allocation of a vertex into an initial vertex packet, i.e. such that any vertex attribute processing is only performed for those vertices that have been allocated to an initial vertex packet.

This all will then have the effect of performing any vertex attribute processing (vertex shading) for attributes of vertices conditionally, and “on demand”, based on, and in dependence upon, whether the vertex is included in an initial vertex packet (and thus in an assembled primitive) or not.

The vertex attribute processing that is performed when generating/for the vertices of a respective viewpoint vertex packet can comprise any suitable and desired vertex attribute processing that may be performed for the vertex data (vertices) of a vertex packet.

The vertex attributes that are processed for the vertices at this stage can be any suitable and desired vertex attributes (attributes that are associated with the vertices in the set of vertices of the vertex packet).

For instance, each vertex will in an embodiment have and has associated with it a set of one or more vertex attributes (vertex attribute data (values)), such as one or more of, and in an embodiment all of: position (e.g. x, y, z, w coordinates/values for the vertex), colour (e.g. RGB values for the vertex), transparency (an alpha value for the vertex), etc. In an embodiment, each vertex has associated with it a position (position data) and one or more other, non-position attributes (data), e.g. defining colour, light, normal, texture coordinates, etc, for the vertex in question.

It would be possible in this regard to process all of the attributes (the data values for all of the attributes) associated with each vertex, or only a subset of some but not all of the attributes for the vertices, at this stage (with, e.g., and in an embodiment, the attributes that are not processed at this stage then being processed at a later stage of the graphics processing pipeline).

In an embodiment, at least a position is processed by the vertex attribute processing that generates/of the respective viewpoint vertex packets. In an embodiment, only a position attribute (the position) is processed for the vertices of the vertex packets.

Thus, in an embodiment, only position attribute(s) are processed at this stage (and thus in an embodiment no non-position attributes are processed at this stage), but it would be possible to process one or more other (non-position) attributes as well as one or more position attributes, if desired.

(For any attributes that are not processed at this stage (not subjected to any vertex shading at this stage), those attributes can be, and are in an embodiment subjected to any required vertex shading at a later time, e.g. at the time that they are fetched for use (at the appropriate later stage of the graphics processing pipeline, e.g. where they are fetched for use).)

The vertex attribute processing (vertex shading) that is triggered and performed in this regard can be any suitable and desired vertex attribute processing (vertex shading), e.g., and in an embodiment, in dependence upon the vertex attributes that are being processed.

Thus where, as discussed above, a position is processed for a vertex, then in an embodiment the position (position attribute) is subjected to appropriate processing (vertex shading), e.g., and in an embodiment, to transform the position from the (e.g. model) space that it is initially defined in, to the appropriate (e.g. screen) space for the output that is being generated. Thus, in an embodiment, (any) positions of the vertices that are being processed are subjected to an appropriate processing (vertex shading) operation.

As the different viewpoints when performing multi-view rendering can be, and typically will be, at different positions with respect to the scene, and as the vertices can be, and typically will be, initially defined with respect to a model space, the transformations required to transform the positions of the vertices in the vertex packets from model (world) space to their positions in the screen space with respect to the viewpoints may be, and typically will be, different for each viewpoint (because the viewpoints are at different positions).

Thus, transforming the position of a vertex from the space that it is initially defined in, to the appropriate space for the output that is being generated is in an embodiment done in dependence on which viewpoint of the plurality of viewpoints the vertex is for (i.e. which viewpoint the vertex packet that the vertex is in is for).

In an embodiment, a vertex attribute processing stage (vertex attribute processing circuit) of the graphics processing pipeline, when performing vertex attribute processing to generate/of a respective viewpoint vertex packet, will perform the vertex attribute processing in dependence on the viewpoint identifier for the respective viewpoint vertex packet (e.g. by using metadata, e.g. a header portion, for a respective viewpoint vertex packet to determine the viewpoint identifier for the (respective viewpoint) vertex packet (to determine which particular one of the viewpoints of the plurality of viewpoints being rendered the respective viewpoint vertex packet is for), and then performing vertex attribute processing for the respective viewpoint vertex packet based on the viewpoint identifier.).

As discussed above, the vertex position attribute processing for the respective viewpoint vertex packets can be dependent on the particular viewpoint that a respective viewpoint vertex packet is for (as the position transformations for the different viewpoints can be different).

The vertex attribute processing is therefore in an embodiment configured to use a particular processing operation (transform) for a respective viewpoint vertex packet based on the viewpoint identifier of the respective viewpoint vertex packet to perform position attribute processing for the vertices of the respective viewpoint vertex packet.

When a vertex attribute is subjected to vertex processing (vertex shading), then the processing of the attribute in an embodiment provides both the processed (shaded) attribute value or values itself, together with any other data values, such as state information, that may be generated as a result of the vertex processing (vertex shading). Other arrangements would, of course, be possible.

The actual vertex attribute, e.g. position, processing (shading) can be performed in any suitable and desired manner.

In an embodiment, as described above, the graphics processor includes and executes an appropriate vertex attribute processing stage (vertex attribute processing circuit) that is operable and configured to process vertex attributes for vertices defined for a render output, which performs the desired vertex attribute processing. Thus, in an embodiment, the vertex attribute processing stage (circuit) is operable and configured (at least) to process (transform) vertex positions for vertices.

In an embodiment the vertex attribute processing stage (circuit) is operable to, and configured to, execute an appropriate vertex shader (e.g. position shader) to perform the vertex attribute processing (shading), with the result of that vertex shading (e.g. position shading) operation then being stored for the vertex, e.g., and in an embodiment in the (processed) vertex packet.

The vertex attribute processing itself can be performed in any suitable and desired manner. It will, for example, and in an embodiment, comprise fetching the relevant attributes (e.g. positions) for the vertices of the respective viewpoint vertex packet from where they are stored in memory (e.g., and in an embodiment, based on, and using, the vertex indices of the vertices for the vertex packet in question), appropriately processing those vertex attributes (e.g., and in an embodiment, subjecting them to appropriate vertex shading), and then storing the processed attributes (e.g. positions) for the vertices of the vertex packet in association with each other (together), e.g., in memory, to thereby provide a “vertex shaded” vertex packet comprising the processed vertex attributes for the vertices of the viewpoint vertex packet.

Once the appropriate vertex attribute processing (vertex shading) has been performed for the vertices of a respective viewpoint vertex packet, a viewpoint vertex packet comprising the appropriately processed attributes (e.g. transformed positions) for the vertices of the respective viewpoint vertex packet will have been generated and stored, e.g., and in an embodiment in memory (and from where the appropriately processed vertex attributes (e.g. transformed positions) for the vertices of the viewpoint vertex packet can then be retrieved and used by and for later stages of the graphics processing pipeline).

From the above description, it will be appreciated that in an embodiment, generating, for each viewpoint of the plurality of viewpoints, a respective viewpoint vertex packet using an initial vertex packet comprises:
sending the initial vertex packet for vertex attribute processing (in an embodiment, position-only vertex attribute processing) a plurality of times corresponding to the number of viewpoints of the plurality of viewpoints, in an embodiment wherein each time the initial vertex packet is sent for the vertex attribute processing it is associated with a particular one of the viewpoints (in an embodiment, each vertex packet sent for vertex attribute processing is associated an appropriate viewpoint identifier indicating which viewpoint of the plurality of viewpoints the vertex packet is for); in an embodiment
performing the (in an embodiment, position-only) vertex attribute processing on the initial vertex packet based on which viewpoint the packet is for (in an embodiment, wherein the vertex attribute processing is performed on a vertex packet based on the appropriate viewpoint identifier indicating which viewpoint of the plurality of viewpoints the vertex packet is for) (the so-vertex attribute processed vertex packets then forming the vertex viewpoint vertex packets).

From the above description, it will be appreciated that in another embodiment, generating, for each viewpoint of the plurality of viewpoints, a respective viewpoint vertex packet using an initial vertex packet comprises:
duplicating the initial vertex packet (the vertices of the initial vertex packet) into a number of vertex packets to give a set of vertex packets corresponding to the number of viewpoints in the plurality of viewpoints, and in an embodiment associating each of those vertex packets with a particular one of the viewpoints (in an embodiment by, associating to each vertex packet of the set of vertex packets an appropriate viewpoint identifier indicating which viewpoint of the plurality of viewpoints the vertex packet is for); and in an embodiment
performing (in an embodiment, position-only) vertex attribute processing for the vertex packets of the set of vertex packets based on which viewpoints the vertex packets are for (in an embodiment, based on the viewpoint identifiers for the vertex packets) (the so-vertex attribute processed vertex packets then forming the vertex viewpoint vertex packets).

The assembled primitives and the generated and shaded respective viewpoint vertex packets comprising the processed vertex attributes should then be, and are in an embodiment, provided to later stages of the graphics processing pipeline that is being executed by the graphics processor for further processing. This may be done in any suitable and desired manner, and the further processing can comprise any suitable and desired further processes that may be performed by, and as a part of, a graphics processing pipeline.

The graphics pipeline can perform the further processing on/using the viewpoint vertex packets for the viewpoints to render the scene from the plurality of viewpoints in any suitable and desired manner.

In embodiments, the viewpoint vertex packets are further processed on a viewpoint-per-viewpoint basis (e.g. further processing is performed on (using) the viewpoint vertex packets such that the scene is rendered one viewpoint at a time). In other embodiments, the viewpoint vertex packets may be, and in an embodiment are, further processed in an interleaved manner (such that the viewpoint vertex packets for different viewpoints are processed through the pipeline in an interleaved manner (the scene is rendered for a plurality of the viewpoints at the same time)). Other arrangements are of course possible.

The further processing can, and in an embodiment does comprise one or more of, and in an embodiment plural of: storing respective viewpoint vertex packets in (cache) memory, re-indexing of the assembled primitives with respect to the shaded viewpoint vertex packets, primitive and fragment processing, as well as further vertex shading to shade any vertex attributes not already shaded when generating the respective shaded viewpoint vertex packets.

In an embodiment, this comprises rasterising primitives to be processed to fragments, fragment shading (processing) of the fragments, fragment culling, rendering, and/or performing ray tracing operations.

The rendering/fragment processing that is performed can be any suitable and desired rendering/fragment processing that may be performed by a graphics processor and a graphics processing pipeline. Thus this may comprise, for example, rasterising primitives to fragments and fragment shading the fragments, and/or performing ray tracing processes, etc.

In this respect, the graphics processing pipeline, and the processing stages of the pipeline, can comprise any suitable and desired stages (circuits) for performing any suitable and desired rendering/fragment processing, such as suitable rasteriser stages, fragment processing stages, culling stages, rendering stages, ray tracing stages, etc.

In an embodiment, the graphics processor comprises, and/or is in communication with, one or more memories and/or memory devices that store the data described herein, and/or that store software for performing the processes described herein. The graphics processor may also be in communication with a host microprocessor, and/or with a display for displaying images based on the output of the graphics processor.

The output to be generated may comprise any output that can and is to be generated by the graphics processor and processing pipeline. Thus it may comprise, for example, a tile to be generated in a tile based graphics processing system, and/or a frame of output fragment data. The technology described herein can be used for all forms of output that a graphics processor and processing pipeline may be used to generate, such as frames for display, render-to-texture outputs, etc. In an embodiment, the output is an output frame, and in an embodiment an image.

In an embodiment, the various functions of the technology described herein are carried out on a single graphics processing platform that generates and outputs the (rendered) data that is, e.g., written to a frame buffer for a display device.

The various functions of the technology described herein can be carried out in any desired and suitable manner. For example, unless otherwise indicated, the functions of the technology described herein herein can be implemented in hardware or software, as desired. Thus, for example, unless otherwise indicated, the various functional elements, stages, and “means” of the technology described herein may comprise a suitable processor or processors, controller or controllers, functional units, circuitry, circuits, processing logic, microprocessor arrangements, etc., that are configured to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuitry/circuits, etc., if desired.

Furthermore, unless otherwise indicated, any one or more or all of the processing stages of the technology described herein may be embodied as processing stage circuits, e.g., in the form of one or more fixed-function units (hardware) (processing circuits), and/or in the form of programmable processing circuits that can be programmed to perform the desired operation. Equally, any one or more of the processing stages and processing stage circuits of the technology described herein may be provided as a separate circuit element to any one or more of the other processing stages or processing stage circuits, and/or any one or more or all of the processing stages and processing stage circuits may be at least partially formed of shared processing circuits.

Subject to any hardware necessary to carry out the specific functions discussed above, the graphics processor can otherwise include any one or more or all of the usual functional units, etc., that graphics processors include.

It will also be appreciated by those skilled in the art that all of the described embodiments of the technology described herein can, and, in an embodiment, do, include, as appropriate, any one or more or all of the features described herein.

The methods in accordance with the technology described herein may be implemented at least partially using software e.g. computer programs. It will thus be seen that the technology described herein herein may provide computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus, in a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible, non-transitory medium, such as a computer readable medium, for example, diskette, CDROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrinkwrapped software, preloaded with a computer system, for example, on a system ROM or fixed disk, or distributed from a server or electronic bulletin board over a network, for example, the Internet or World Wide Web.

Embodiments of the technology described herein will now be described.

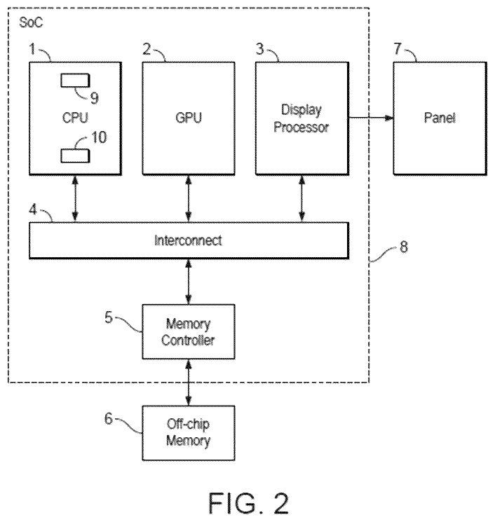

FIG. 2 shows an exemplary system on chip (SoC) graphics processing system 8 that comprises a host processor comprising a central processing unit (CPU) 1, a graphics processor (GPU) 2, a display processor 3, and a memory controller 5. The exemplary data processing system may also comprise a video engine (not shown in FIG. 2). As shown in FIG. 2, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

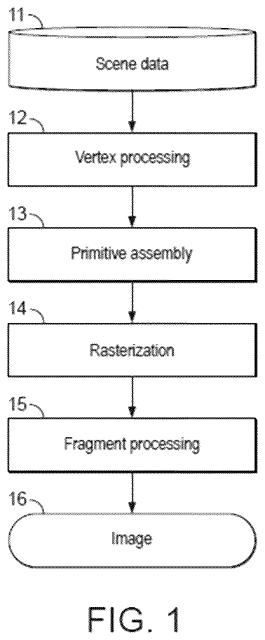

In the present embodiment, the graphics processor 2 executes a graphics processing pipeline that processes graphics primitives, such as triangles, when generating an output, such as an image for display. The graphics processing pipeline includes and performs similar operations to those illustrated in the graphics processing sequence shown in FIG. 1, but in the present embodiments, and as will be discussed further below, the primitive assembly process also generates “vertex packets” comprising vertices of assembled primitives in the manner of the technology described herein.

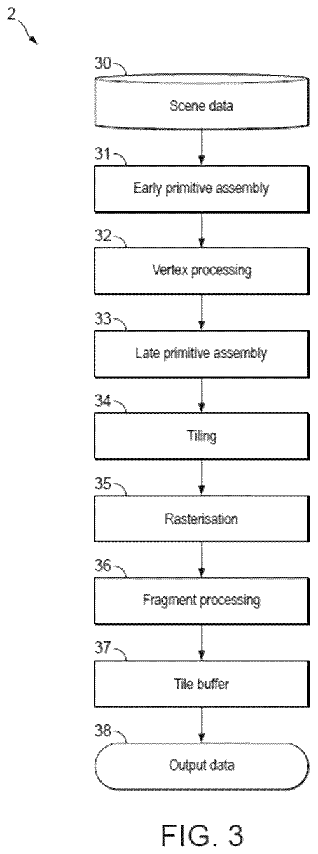

FIG. 3 shows schematically the graphics processor 2 and the processing sequence of the graphics processing pipeline executed by the graphics processor 2 when generating an output in the present embodiments.

FIG. 3 shows the main elements and pipeline stages/circuits. As will be appreciated by those skilled in the art there may be other elements of the graphics processor and processing pipeline that are not illustrated in FIG. 3. It should also be noted here that FIG. 3 is only schematic, and that, for example, in practice the shown functional units and pipeline stages may share significant hardware circuits, even though they are shown schematically as separate stages in FIG. 3. It will also be appreciated that each of the stages, elements and units, etc., of the graphics processor and processing pipeline as shown in FIG. 3 may, unless otherwise indicated, be implemented as desired and will accordingly comprise, e.g., appropriate circuitry, circuits and/or processing logic, etc., for performing the necessary operation and functions.

As shown in FIG. 3, again for an output to be generated, a set of scene data 30, including, inter alia, a set of vertices (with each vertex having one or more attributes, such as positions, colours, etc., associated with it), a set of indices referencing the vertices in the set of vertices, and primitive configuration information indicating how the vertex indices are to be assembled into primitives for processing when generating the output, is provided to the graphics processor, for example, and in an embodiment, by storing it in the memory 6 from where it can then be read by the graphics processor 2.

This scene data may be provided by the application (and/or the driver in response to commands from the application) that requires the output to be generated, and may, for example, comprise the complete set of vertices, indices, etc., for the output in question, or, e.g., respective different sets of vertices, sets of indices, etc., e.g. for respective draw calls to be processed for the output in question. Other arrangements would, of course, be possible.

Then, in the present embodiments, an “early” primitive assembly stage (circuit) 31 operates to assemble primitives for processing using the provided set of indices referencing the vertices based on the provided primitive configuration information, to generate a sequence of assembled primitives, each primitive comprising at this stage an identifier for the primitive and a set of one or more vertex indices for the primitive. This operation will be discussed in more detail below.

The assembled primitives from the primitive assembly stage (circuit) 31 are then used to trigger the fetching and vertex processing (shading) 32 of attributes for the vertices for the assembled primitives. In the present embodiments the fetching of the vertex positions and the transforming of the positions for the vertices from the, e.g. “model” space in which they are initially defined, to the, e.g. “screen”, space that the output image is being generated in is triggered and performed at this stage (but the fetching and shading of any other vertex attributes is triggered and performed at later stages of the graphics processing). Again, this operation will be discussed in more detail below.

There is then a “late” primitive assembly stage (circuit) 33 that assembles primitives for further processing from the sequence of primitives output by the early primitive assembly stage (circuit) 31 (and in particular using the indices for those primitives), by associating the primitives output by the early primitive assembly stage (circuit) 31 with the corresponding fetched and shaded vertex attributes from the vertex processing 32, to provide a sequence of assembled primitives, each primitive comprising an identifier for the primitive and the relevant fetched (and shaded) vertex attributes (positions) (and any other fetched data) for the vertices for the primitive. Again, this operation will be discussed in more detail below. Other (non-position) vertex attributes, such as colours, transparency, etc., that are needed will be fetched (and as necessary “vertex shaded”) later on in the pipeline, for example at the tiling stage (tiler).)

The assembled primitives with the fetched and processed vertex attributes (positions) from the late primitive assembly 32 are first passed to a tiler (tiling circuit) 34 for processing. (It is assumed in this regard that the graphics processor 2 in the present embodiments is a tile-based graphics processor and so generates respective output tiles of an overall output (e.g. frame) to be generated separately to each other, with the set of tiles for the overall output then being appropriately combined to provide the final, overall output.)

The tiler 34 performs the process of “tiling” to allocate the assembled primitives to primitive lists for respective render output regions (areas) which are then used to identify the primitives that should be rendered for each tile that is to be rendered to generate the output data (which may, e.g. be a frame to be rendered for display). For example, the tiler 34 may be implemented using a primitive list building unit which takes the assembled primitives as its input, builds primitive lists using that data, and stores the primitive lists in memory. The tiler may also cull certain primitives that are not visible.

(Other arrangements for allowing primitives to be processed for a rendering tile to be identified, such as the use of hierarchies of bounding boxes for primitives, could also or instead be used, if desired.)

The rasterisation stage (circuit) (rasteriser) 35 takes as its input the primitives (including their vertices), from the primitive list(s) for the tile being rendered, rasterises the primitive to fragments, and provides the fragments to a fragment processing stage (circuit) 36, which in this embodiment comprises a shader execution engine (a shader core). The shader execution engine is a programmable execution unit that performs fragment shading by executing fragment shading software routines (programs) for fragments received from the rasteriser 35.

Each graphics “fragment” that is shaded may correspond to a single pixel (picture element) in the final display (since as the pixels are the singularities in the final display, there may be a one-to-one mapping between the “fragments” the graphics processor operates on (renders) and the pixels of the display). However, it can be the case that there is not a one-to-one correspondence between a fragment and a display pixel, for example where particular forms of post-processing, such as down-scaling, are carried out on the rendered image prior to displaying the final image.

Each fragment will be processed by means of one or more execution threads which will execute the instructions of the shader program in question for the fragment in question. Typically, there will be multiple execution threads each executing at the same time (in parallel).

Other rendering processes, such as ray-tracing, and/or hybrid ray-tracing, could also or instead be used, if desired.

The output of the fragment processing 36 (the rendered fragments) is written to a tile buffer 37. Once the processing for the tile in question has been completed, then the tile will be written to the output data array 38 in memory, and the next tile processed, and so on, until the complete output data array has been generated. The process will then move on to the next output data array (e.g. frame), and so on.

The output data array 38 may typically be an image for a frame intended for display on a display device, such as a screen or printer, but may also, for example, comprise intermediate render data intended for use in later rendering passes (also known as a “render to texture” output), or for deferred rendering, or for hybrid ray tracing, etc.

As discussed above, the technology described herein and the present embodiments relate in particular to the idea of generating vertex packets for multi-view rendering from other, initially generated, vertex packets.

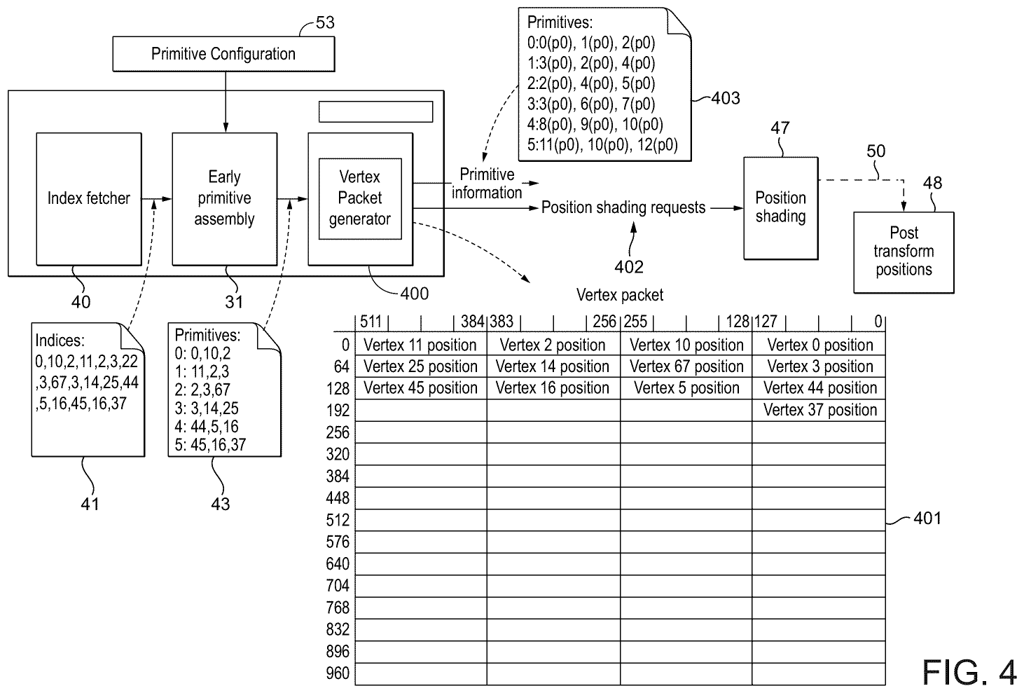

FIG. 4 shows the generation of a vertex packet by one or more stages of a sequence of one or more geometry processing stages. In particular, FIG. 4, shows the early primitive assembly stage (circuit) 31 of the graphics processor 2 shown in FIG. 3 and its operation in an embodiment of the technology described herein in more detail.

As shown in FIG. 4, the early primitive assembly process and circuit 31 includes an index fetcher (an index fetching circuit) 40 that fetches and outputs a sequence (stream) of indices 41 from the (stored) vertex index array defined and provided for the output being generated.

(As shown in FIG. 4, the same vertex index may appear more than once in the sequence of indices 41 for the output. It may also be the case that some vertices in the set of vertices for the output will not in fact be included in the sequence of indices for the output.)

The index fetcher 40 provides the sequence of indices 41 to the early primitive assembly stage (circuit) 31, which assembles complete primitives 43 from the stream of indices 41 provided by the index fetcher 40, in accordance with primitive configuration information 53 that defines the type of primitives to be assembled (e.g. whether the assembled primitives are to be in the form of triangles, triangle strips, triangle fans, points or lines, etc.). This primitive configuration information (primitive type definition) 53 may be provided, e.g., as part of a descriptor (metadata) for the output being generated.

The early primitive assembly stage (circuit) 31 is operable to output a sequence 43 of complete assembled primitives from the input stream of indices 41 according to the defined primitive type. At this stage, each (complete) primitive output by the early primitive assembly circuit 31 comprises an identifier for the primitive in the form of a sequence number for the primitive, and a sequence of vertex indices from the input index vertex stream, corresponding to the indices for the vertices to be used for the primitive.

In the present embodiment, the early primitive assembly circuit 31 is operable to discard any degenerate or incomplete primitives at this stage, such that only complete primitives (corresponding to the desired primitive type) will be output. The early primitive assembly circuit 31 may also be operable to subdivide more complex primitives into simpler primitives, such as triangles, lines or points, for output, if desired.

It should also be noted that at this stage, only the indices and the primitive configuration information provided to the early primitive assembly circuit (stage) will have been fetched from memory. At this point in the process, no vertex attributes have been fetched or processed (vertex shaded).

As shown in FIG. 4, the sequence 43 of complete assembled primitives from the early primitive assembly stage (circuit) 31 is provided to a vertex packet generator stage (circuit) 400.

The vertex packet generator 400 operates to generate vertex packets 401 comprising vertices of assembled primitives, and in particular operates to generate “initial vertex packets” from which further, respective viewpoint vertex packets, will be generated for multi-view rendering.

Thus, as illustrated in FIG. 4, the vertex packet generator 400 will allocate vertices of assembled primitives that are received from the earlier primitive assembly 31 to a respective initial vertex packet(s) 401 in turn. In the present embodiments, each initial vertex packet 401 has a maximum permitted capacity of vertices, such as 64 vertices, and once that capacity is reached, a new initial vertex packet is started.

FIG. 4 shows the exemplary content of an initial vertex packet 401 for the sequence 43 of primitives 0-5 illustrated in FIG. 4. It will be appreciated that as more primitives are assembled, more vertices will be added to the initial vertex packet 401 until it is full.

In the present embodiments, in order to try to avoid duplication of vertices within vertex packets, the vertex packet generation process keeps track of the vertices that have been added to an initial vertex packet, and checks whether the vertices for new primitives have already been included in an initial vertex packet using that vertex tracking information. In the present embodiments, the inclusion of vertices in vertex packets for the vertex packet generation process is tracked for a plurality of, e.g. four, vertex packets, such that it will not only be checked whether a vertex has already been included in the current vertex packet, it will also be determined whether the vertex has been included in up to three immediately preceding vertex packets.

In the present embodiments, the vertices of assembled primitives are added to initial vertex packets in turn (subject to avoiding any duplication of vertices in the vertex packets), as they appear in assembled primitives. Once a given vertex packet is full (has reached its threshold (maximum) capacity), then a new vertex packet is started.

In these embodiments, vertices of assembled primitives are added to initial vertex packets until the initial vertex packet has reached its threshold capacity of vertices. However, it will also be appreciated that in embodiments vertices of assembled primitives can be added into vertex packets until a threshold number of primitives are associated with the vertex packet (a threshold number of primitives have their vertices contained within the vertex packet).

The vertex packet generator 400 can also re-index the indices of the vertices for the assembled primitives to provide “vertex packet-based” indices for the vertices of the assembled primitives. Thus, as shown in FIG. 4, the vertex packet generator 400 will also output a sequence of assembled primitives 403, but with each primitive comprising a set of vertex indices that each identify the initial vertex packet that the vertex is present in and the position (index) of that vertex in the initial vertex packet in question. Thus, for example, and as shown in FIG. 4, the vertex packet generator will output for the first primitive (having the primitive index 0) comprising the vertices 0, 10, 2 (from the originally provided set of vertex indices), a corresponding set of vertex-packet-based indexes, 0(p0), 1(p0), 2(p0), indicating its vertices.

To facilitate this the initial vertex packets generated by the vertex packet generator 400 are correspondingly indexed in the sequence that they are generated, to thereby provide appropriate identifiers (indexes) for the different vertex packets (and that can be used to identify and track the different vertex packets).

As shown in FIG. 4, the vertex packet generator 400 also triggers the vertex shading of the position attributes 402 for the vertices that have been included in an initial vertex packet.

As shown in FIG. 4, a position shading request 402 is sent to an appropriate position shading stage 47 so that the vertex packets generated by the vertex packet generator 400 can be appropriately shaded.

The appropriate position shading stage (position shader (circuit)) 47 (appropriate execution (shader) core(s) of the graphics processor) executes appropriate position shading programs for the positions (position attributes) of vertices, to transform the positions from their “model” space definitions to the appropriate “screen” space that the output is being generated with respect to.

The position shading request 402 for the vertices of a vertex packet will indicate, inter alia, the indices from the initially provided set of indices for the draw call of the vertices in the vertex packets, so that the appropriate vertices to be position shaded for the vertex packet can be identified. The request may also indicate, for example, and in an embodiment, the position shading operation to be performed (the position shader to be executed), and where the vertex packet, containing the shaded positions for the vertices of the vertex packet should be stored. The request may also indicate that multi-view rendering is to be performed, so that the position shading stage can configure the position for each vertex packet appropriately.

In this respect, each vertex will be processed (position shaded) by means of one or more execution threads which will execute the instructions of the (position) shader program in question for the vertex in question. Typically, there will be multiple execution threads each executing at the same time (in parallel).

The position shading process (position shader) 47 executes the position shading programs on a respective programmable processing (execution) core (shader core) or cores of the graphics processor 2.

In the case where the execution (shader) core or cores of the graphics processor are operable to execute plural execution threads (each representing an individual vertex) as a group (warp) together, then the position shading for the vertex packets is in an embodiment performed by executing the position shading as, and for, one or more thread groups (warps). For example, where a vertex packet has a capacity of 64 vertices, and the execution core(s) are operable to execute groups (warps) of 16 threads, then the position shading for a given vertex packet will be performed by issuing four respective thread groups (warps) for execution to perform that position shading.

The processed vertex packets, containing the shaded (transformed) positions, are stored 50 in a post-transform position buffer 48, in memory, from where they can then be fetched for use.

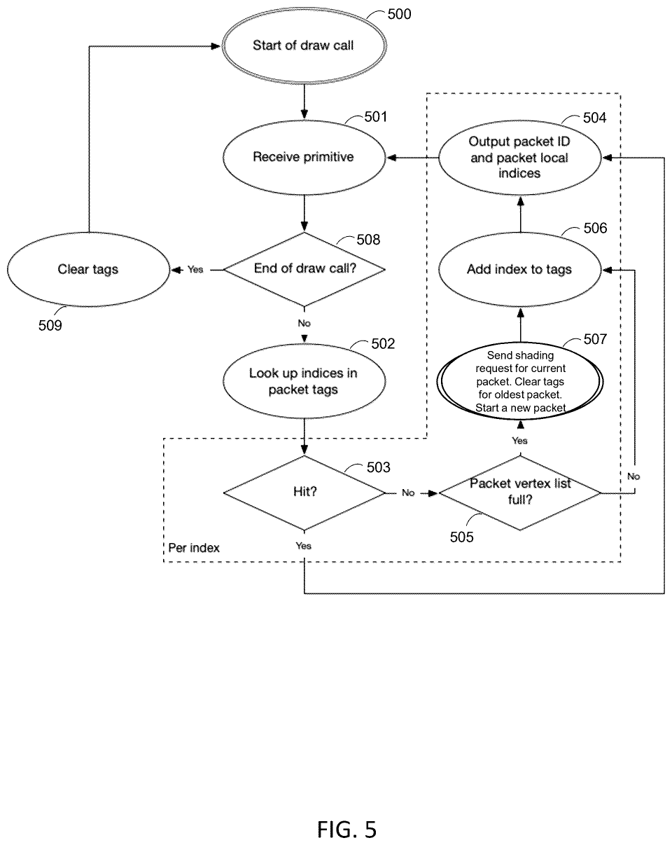

FIG. 5 shows this operation of the vertex packet generator 400 in the present embodiments in more detail.

For the operation illustrated in FIG. 5, it is assumed that the primitives are assembled for respective draw calls, and that for each respective draw call for a render output, a separate sequence of primitives will be assembled and processed.

Thus, as shown in FIG. 5, once a new draw call is started (step 500) the vertex packet generator 400 will receive 501 the assembled primitives for the draw call from the early primitive assembly 31 in turn, and for each primitive, look up the vertex indices for the primitive in tracking information (tags) that is used to track which vertices have been included in a vertex packet (step 502).

As shown in FIG. 5, for each vertex index for a primitive, it is determined whether that vertex is already present in an initial vertex packet (step 503), and if the vertex is already present in an initial vertex packet, then the corresponding packet ID and packet local index for the vertex in question is output (step 504), for provision with and for the assembled primitive using the vertex-packet-based indexing scheme. On the other hand, when at step 503 it is determined that the vertex for a primitive is not already present in an initial vertex packet, it is then determined whether the current vertex packet is full (has reached its threshold maximum capacity) (step 505).

When the current vertex packet is not full, then the vertex is added to the current initial vertex packet and the (initial, non-vertex packet based) index for the added vertex is added to the vertex tracking information (tags) for the initial vertex packet in question (step 506). The corresponding vertex packet ID and packet local index is again then output for the vertex in question (step 504).

On the other hand, when in step 505 it is determined that the current initial vertex packet is full (i.e. such that a new vertex packet should be started), then the appropriate position shading request is sent for the packet which has just become full (step 507).

A new packet is then started after clearing the vertex index tracking information (tags) for the oldest vertex packet (step 507).

(As discussed above in the present embodiments, the vertex packet vertex tracking is performed for a queue of, e.g. four vertex packets, with new vertex packets (when required) being added to the end of the queue and correspondingly the oldest vertex packet being evicted from the head of the queue. Once a packet is evicted from the queue it is no longer tracked and checked whether later assembled primitives include vertices within that evicted vertex packet. Rather, if a later assembled primitive includes again a vertex that was in a vertex packet which has been evicted, that vertex will simply be added again to the current vertex packet.) As before, the index for the new vertex is added to the tracking information for the new vertex packet (step 506), and the new vertex packet ID and packet local index for the vertex in question is output (step 504) for association with the assembled primitive.

It may not be necessary to wait until a packet is full before starting to send vertex shading requests. Vertex shading requests could (additionally or alternatively) be sent whilst a packet is being generated (e.g. in response to a predetermined number of vertexes being added to the packet currently being generated). For example, a shading request could be (and in an embodiment is) triggered for the current packet (to which the vertices having a “miss” at step 503 are added) after a predetermined number of “misses” occur (for example corresponding to the number of execution threads of the shader core, e.g. 16).

Vertex shading is in an embodiment not performed (repeated) for those vertices which are determined to be already present in a vertex packet (of the e.g. four vertex packets) being tracked, i.e. for which a “hit” occurs at step 503, since shading will have already been performed for those vertices.

This operation shown in FIG. 5 is repeated for all the primitives within the draw call, until the end of the draw call is reached (step 508), at which point all the vertex tracking information is cleared (step 509), so that the process can be started again for the next draw call (if any).

This process will be repeated for each draw call of a render output to be generated (and for subsequent render outputs, as appropriate).

The technology described herein is particularly related to rendering a scene for a plurality of viewpoints, i.e. to multi-view rendering.

Multi-view rendering is typically performed in the case of virtual reality (VR) and/or augmented reality (AR) display, where a scene is to be rendered from two viewpoints, e.g. for stereoscopic rendering, but can also be used in other cases.

When performing multi-view rendering, for each viewpoint to be rendered, the vertices in the scene typically have to be processed differently due to the different positions of the viewpoints within the scene (as the viewpoints can be, and typically are, at different positions within the scene).

As such, in the present embodiments, “viewpoint” vertex packets comprising vertices for assembled primitives in the scene are generated for each viewpoint being rendered using an “initial” vertex packet, each viewpoint vertex packet being (exclusively) associated with one of the viewpoints being rendered.

Correspondingly, where a sequence of “initial” vertex packets is generated, e.g. as described with relation to FIGS. 4 and 5, each of the initial vertex packets is used to generate, for each of the viewpoints, a corresponding sequence of viewpoint vertex packets, so that the vertices for the assembled primitives can be appropriately processed for each of the viewpoints (and accordingly so that the scene can be rendered for the plurality of viewpoints).

In the present embodiments, the respective viewpoint vertex packets are generated when an “initial” vertex packet is generated and sent for shading.

The position shading request 402 for an initial vertex packet therefore triggers the generation of the respective viewpoint vertex packets.

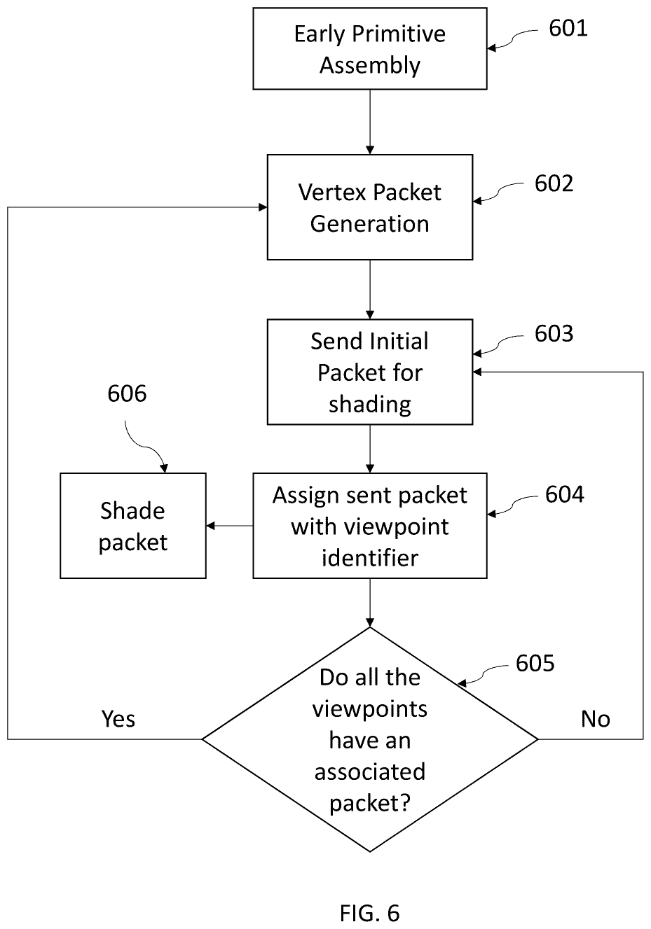

In this respect, FIG. 6 shows a process for generating the viewpoint vertex packets in an embodiment of the technology described herein.

In particular, FIG. 6 illustrates a process of generating respective viewpoint vertex packets by repeatedly sending a vertex packet for shading a number of times corresponding to the number of viewpoints being rendered.

As shown in FIG. 6, firstly, primitives are assembled (step 601), e.g. using the process described with relation to the early primitive assembly stage (circuit) 31 of FIG. 4, and the sequence (stream) of vertex indices output from the early primitive assembly is provided to the vertex packet generator (e.g. the vertex packet generator 400 discussed with relation to FIGS. 4 and 5). The vertex packet generator uses the sequence of vertex indices to generate an initial vertex packet (step 602) (as described above).

Once an initial vertex packet has been generated by the vertex packet generator, it is sent for vertex shading (step 603).

At this point, as shown in FIG. 6, and as described below, the respective viewpoint vertex packets are generated by repeatedly sending the initial vertex packet for vertex shading, and associating each sent initial vertex packet with a particular one of the viewpoints, until each of the viewpoints of the plurality of viewpoints have associated with them a respective (vertex-shaded) viewpoint vertex packet (generated using the initial vertex packet).

In the present embodiments, to be able to distinguish which vertex packets sent for shading are for which particular viewpoints, the initial vertex packet is associated with a viewpoint identifier that uniquely identifies which of the viewpoints the vertex packet is for as it is sent for shading (step 603). In the present embodiments, as the vertex packet is sent for shading, it is assigned a “viewpoint identifier” in a header portion of the packet.

In this embodiment, the identifier is assigned to the vertex packets sent for shading by the vertex packet generator circuit 400 as and when the initial vertex packet is sent for shading, but other arrangements are of course possible.

Further, in the present embodiments, so that each of the vertex packets sent for shading are uniquely assigned to particular ones of the viewpoints, the viewpoint identifier is changed (incremented) to the next viewpoint in the plurality of viewpoints every time the same initial vertex packet is sent for shading (correspondingly, this can be reset when a new initial vertex packet is to be sent for shading).

After a packet has been assigned a viewpoint identifier, it is vertex shaded by an appropriate vertex shading stage to generate a shaded vertex packet (the shaded vertex packet being associated with a particular one of the viewpoints by way of the viewpoint identifier) (step 605). In the present embodiments, as will be discussed in more detail below, the packets are position-only shaded, and are shaded in dependence on which viewpoint the packet is for (e.g. based on the viewpoint identifier for the packet being shaded) so that the positions of the vertices for a viewpoint can be correctly transformed with respect to that viewpoint.

The shaded vertex packets thus form respective ((position) shaded) “viewpoint” vertex packets, comprising shaded vertices.

As described above, the process to generate the vertex packets for the viewpoints is iterative, and involves repeatedly sending the same initial vertex packet for shading.

As such, in the present embodiments, after an initial vertex packet has been associated with a viewpoint identifier, it is determined whether every viewpoint of the plurality of viewpoints has been associated with an initial vertex packet that has been sent for shading (i.e. it is determined whether the vertex packet has been sent for shading a number of times corresponding to the number of viewpoints being rendered).

If all of the viewpoints of the plurality of viewpoints have associated with them (distinct) vertex packets (originating from the same initial vertex packet) (step 605—yes), then the vertex packet generator generates the next initial vertex packet (step 602), and correspondingly, the next set of vertex packets for the viewpoints.

Otherwise, if all of the viewpoints of the plurality of viewpoints do not have associated with them a respective vertex packet (step 605—No), then the initial vertex packet is sent for shading again (step 603) where it is associated with another (not yet associated with) viewpoint of the plurality of viewpoints.

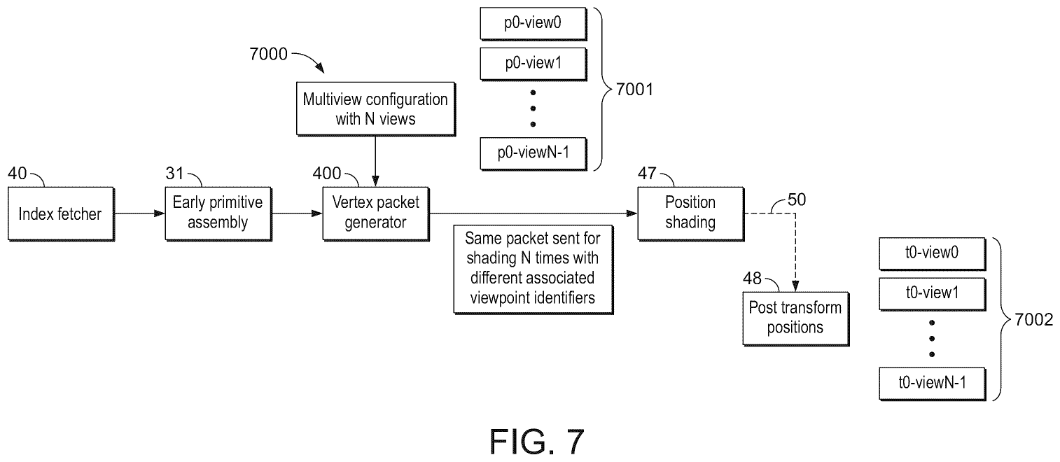

FIG. 7 is similar to FIG. 4 and shows the generation and shading of vertex packets for multi-view rendering, e.g. in the manner described in relation to FIG. 6.

When performing multi-view rendering in the present embodiments, the vertex packet generator is made aware that multi-view rendering is to be performed, and for how many viewpoints (so that it can send the same vertex packet for shading a number of times corresponding to the number of viewpoints to be rendered). FIG. 7 shows that this can be done by way of indicator 7000 provided to the vertex packet generator 400 that indicates to the vertex packet generator 400 that the scene is to be rendered from N viewpoints.

As shown in FIG. 7, when the vertex packet generator 400 has indicated to it that a scene is to be rendered for multiple, N, viewpoints, by way of the indicator 7000, the vertex packet generator 400 will generate an initial vertex packet, or a sequence of initial vertex packets if appropriate, as described in relation to FIGS. 4 and 5, and then send each initial vertex packet generated for (position only) vertex shading a number of times corresponding to the number of viewpoints to be rendered, N.

As described with regard to FIG. 6, this can include sending position shading request 402 for each initial vertex packet generated by the vertex packet generator 400, which, in this embodiment, results in repeatedly sending the same vertex packet for shading a number of times corresponding to the number of viewpoints to be rendered. However, other arrangements are of course possible.

Thus, as shown in FIG. 7, for a given initial vertex packet, N viewpoint vertex packets 7001 are sent for shading (one after the other), each of the N viewpoint vertex packets being associated with a particular one of the viewpoints by way of appropriate viewpoint identifiers (view0 to viewN-1).

In this embodiment, the viewpoint identifiers are associated with the sent vertex packets by the vertex packet generator 400 as and when an initial vertex packet is sent for shading, but other arrangements are of course possible (e.g. the viewpoint identifiers can be associated with the sent initial vertex packets by another viewpoint identifier associating circuit (not shown), or by the vertex attribute shading stage 47 which receives the packets for shading).

The viewpoint vertex packets 7001 at this stage comprise corresponding vertices, e.g. all comprise the vertices of packet 401, but are associated with different viewpoints by way of appropriate viewpoint identifiers in metadata (e.g. in a header portion) of the packet.

As shown in FIG. 7, the viewpoint vertex packets 7001 are (in turn) received by an appropriate position shading stage (position shader (circuit)) 47, e.g. the position shading stage 47 described in relation to FIG. 4.

The position shading stage 47 performs position-only vertex shading for the vertices of the viewpoint vertex packets 7001 to generate position shaded viewpoint vertex packets 7002.

When performing the position vertex shading for a given viewpoint vertex packet 7001, the position only vertex shading performed by the position shading stage 47 is appropriately configured for the viewpoint associated with the viewpoint vertex packet 7001 in question.

That is, as the different viewpoints being rendered can be, and typically will be, at different positions relative to the scene, and as the vertices can be, and typically are, initially defined with respect to a model space, the transformations required to transform the vertex attributes of the vertices in the vertex packets from model space to the positions with respect to the viewpoints may be, and typically will be, different for each viewpoint (because the viewpoints are at different positions).

As such, when performing position shading for a given viewpoint vertex packet 7001, the position shading stage 47 appropriately configures the shading being performed for the viewpoint that the viewpoint vertex packet is for by selecting an appropriate transformation to transform the positions of the vertices of the vertex packet in question from model space to their positions with respect to the viewpoint in question.

Position shading request 402, as described above, can indicate to the position shading stage 47 that multi-view rendering is enabled so that the transform can be selected appropriately. However, other arrangements are possible. For instance, an indicator similar to that of indicator 7000 can also be provided to the position shading stage 47 to indicate to the position shading stage 47 that multi-view rendering is to be performed.

In this embodiment, the position shading stage 47 can determine and read the viewpoint identifier associated with the viewpoint packet it is shading and configures the position shading that it performs on the vertices of that packet appropriately, e.g. by selecting the appropriate transform based on the viewpoint identifier for the packet.

In this embodiment, after the position shading stage shades a viewpoint vertex packet 7001, the correspondingly position shaded viewpoint vertex packet 7002 is stored 50 in memory (e.g. in post-transform position buffer 48) from which it can be fetched for use by later stages of the graphics processing pipeline.

As shown in FIG. 7, the position shading stage 47 shades each of the viewpoint vertex packets 7001 that derive from the same initial vertex packet, to generate a corresponding set of shaded viewpoint vertex packets 7002.

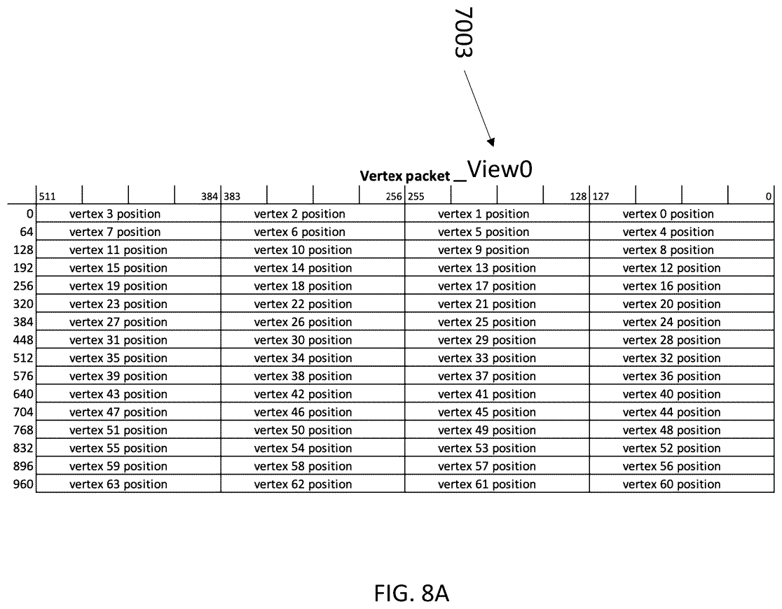

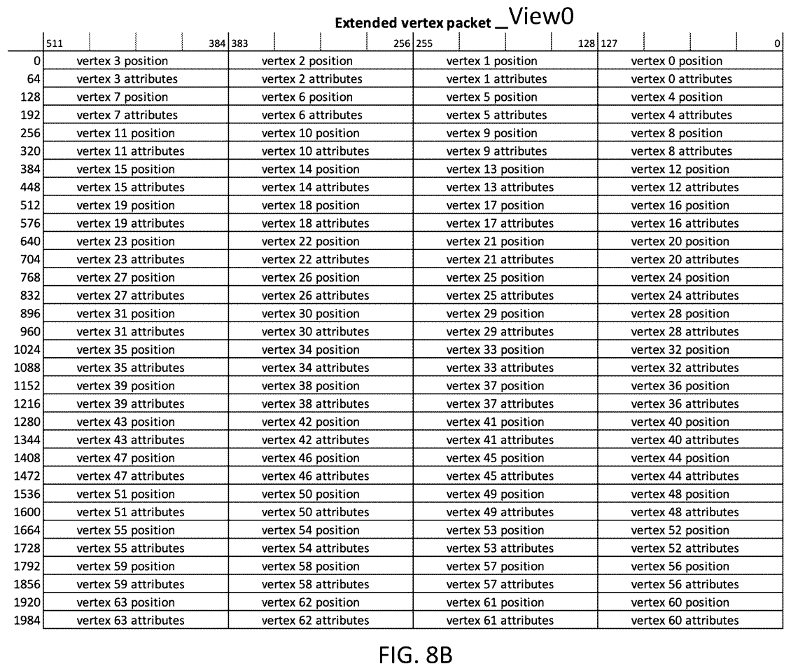

FIG. 8A shows an exemplary position shaded viewpoint vertex packet comprising the transformed positions for all of its vertices, as would, e.g., be generated and stored after the position shading process. FIG. 8A also shows viewpoint identifier 7003 in a header portion of the packet.

As well as generating the appropriately transformed positions for the vertices, the position shading may also generate other parameters, such as one or more of: variable rate shading parameter values, a point size, line width, and/or a layer ID, etc., if desired. In this case, these additional parameters are in an embodiment also stored with the transformed positions in the position shaded vertex packets. FIG. 8B illustrates this, and shows an “extended” vertex packet containing both positions and other attributes for the vertices that it relates to.

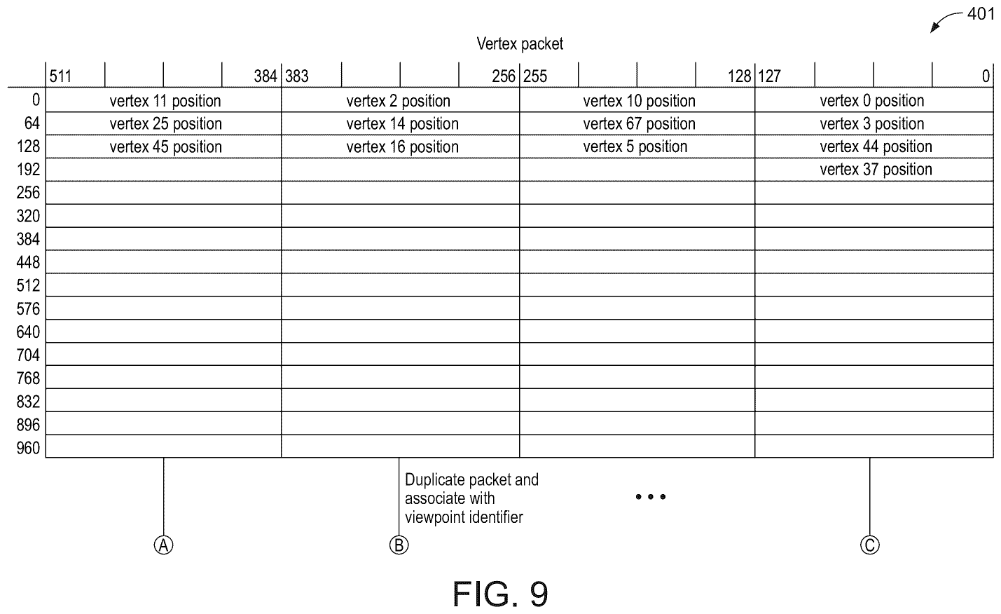

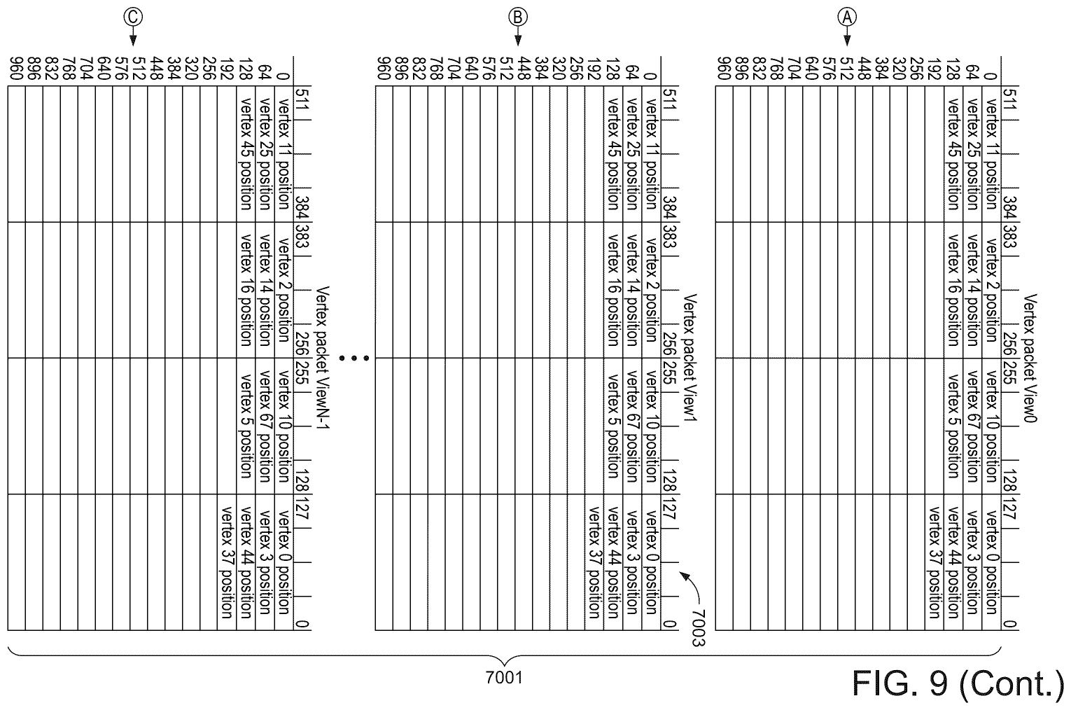

FIG. 9 shows another way to generate vertex packets for viewpoints from an initial vertex packet in an embodiment of the technology described herein.

FIG. 9 shows an initial vertex packet 401. In this embodiment, when the position shading request 402 is sent to position shading stage 47, and when multi-view rendering is to be performed, the viewpoint vertex packets are generated from the initial vertex packet 401 and then shaded.

Thus, as shown in FIG. 9, to generate the viewpoint vertex packets 7001, the initial vertex packet 401 is duplicated N times, N corresponding to the number of viewpoints to be rendered, with each duplicated packet being associated with a viewpoint identifier 7003 in a respective header portion of the packet.

As will be appreciated, rather than duplicating the initial vertex packet N times, the initial vertex packet can be duplicated N-1 times, and the initial vertex packet 401 itself can be associated with one of the viewpoints.

In these embodiments, therefore, instead of repeatedly sending a packet for shading, the packets for the viewpoints are first generated by duplicating the initial vertex packet and then are subsequently shaded, e.g. by position shading stage 47 as described in relation to FIG. 7.

Once the shaded viewpoint vertex packets, including the transformed vertex positions for the vertices of the vertex packets have been generated and stored in memory, they can then be used when and for processing the assembled primitives for the different viewpoints in any suitable and desired manner.

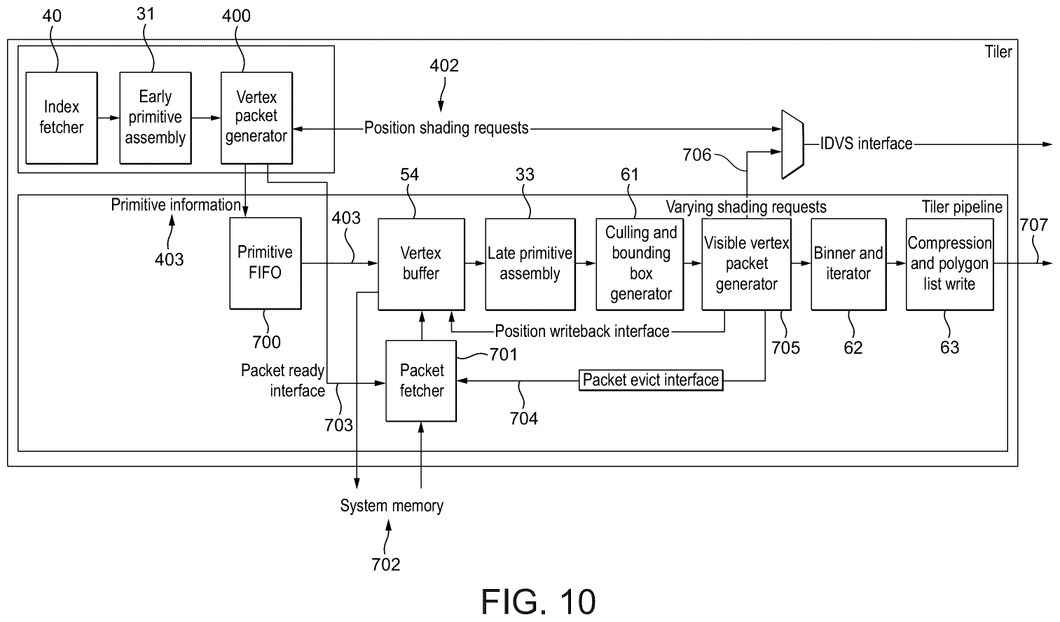

FIG. 10 shows aspects of this operation in an embodiment of the technology described herein.

FIG. 10 shows in particular the next stage of the graphics processing pipeline, which in the present embodiments, comprises a tiling stage of the graphics processing pipeline.

In this regard, the present embodiments relate to and use so-called “tile-based” rendering. In tile-based rendering, the two-dimensional render output (i.e. the output of the rendering process, such as an output frame to be displayed) is rendered as a plurality of smaller area regions, usually referred to as “rendering tiles”. In such arrangements, the render output is typically divided (by area) into regularly-sized and shaped rendering tiles (they are usually rectangles, e.g. squares). (Other terms that are commonly used for “tiling” and “tile-based” rendering include “chunking” (the rendering tiles are referred to as “chunks”) and “bucket” rendering. The terms “tile” and “tiling” will be used hereinafter for convenience, but it should be understood that these terms are intended to encompass all alternative and equivalent terms and techniques wherein the render output is rendered as a plurality of smaller area regions.)

In a tile-based graphics processing pipeline, the geometry (primitives) for the render output being generated may be sorted into regions of the render output area, so as to allow the geometry (primitives) that need to be processed for a given region of the render output to be identified. This sorting allows primitives that need to be processed for a given region of the render output to be identified (so as to, e.g., avoid unnecessarily rendering primitives that are not actually present in a region). The sorting process produces lists of primitives to be rendered for different regions of the render output (referred to herein as “primitive” lists but also commonly referred to as “polygon” or “tile” lists).

A render output region for which a primitive list is prepared could be a single rendering tile, or a group of plural rendering tiles, etc.

Once the primitive lists have been prepared, the primitive lists can then be used by the graphics processor to perform the actual rendering of the rendering tiles, with the information stored in the primitive lists being used to identify the primitives to be processed for each rendering tile when generating the desired render output, e.g. to display the frame.

The process of preparing primitive lists for regions of the render output thus basically involves determining the primitives that should be processed for a given render output region. This process is usually carried out by determining (at a desired level of accuracy) the primitives that intersect (i.e. that will appear (at least in part) within) the render output region in question, and then preparing a list of those primitives for future use by the graphics processing system. Thus, for each primitive to be processed, the graphics processor uses the shaded vertex positions for each primitive for the appropriate viewpoint to determine which region(s) of the render output the primitive at least partially covers (and so should therefore be rendered for).

In the embodiment of FIG. 10, the stages of the graphics pipeline illustrated in FIG. 10 are configured to handle and process each viewpoint being rendered in turn. That is, the subsequent stages, described below, operate to generate the rendered data for a given viewpoint, prior to then generating rendered data for the next viewpoint. However, other arrangements are of course possible. For instance, the graphics pipeline can interleave the processing of different viewpoints so as to render the data for the viewpoints at the same time.

As will be discussed in more detail below, in the present embodiments, the tiling stage uses, inter alia, the transformed positions for the vertices of the assembled primitives from the generated shaded viewpoint vertex packets for a given viewpoint to determine whether assembled primitives are (potentially) visible within the output being generated for the viewpoint in question (and so should be processed further for the output being generated), and, correspondingly, adds any primitives that are determined to be (potentially) visible at the tiling stage appropriately to primitive lists from where they can then be read and processed further.

As shown in FIG. 10, the assembled primitives 403 from the vertex packet generator 400 (i.e. with their vertices indexed using the vertex-packet-based indexing scheme) are provided to a late primitive assembly stage/circuit 33, via a FIFO 700 (which acts as a latency hiding mechanism to allow time for the corresponding position shading to be completed for the vertex packets containing the vertices of the assembled primitives).

The late primitive assembly stage 33 adds the transformed positions to the assembled primitives output by the early primitive assembly stage/circuit 31, and provides the so-assembled primitives to subsequent stages of the tiling process.

As shown in FIG. 10, the late primitive assembly stage 33 acquires the transformed positions for the assembled primitives for this purpose from a vertex buffer 54, that stores the transformed positions for vertices of assembled primitives for use then by the late primitive assembly stage 33. In particular, the late primitive assembly stage 33 acquires the transformed positions for viewpoint in question (i.e. from the position shaded viewpoint vertex packets for the viewpoint in question).

In the present embodiments, the vertex buffer 54 is configured to store a number of entire vertex packets (including the transformed positions). For example, the vertex buffer 54 may store up to seven vertex packets. Other arrangements would, of course, be possible.

To facilitate this operation, as shown in FIG. 10, the graphics processor also includes an appropriate packet fetcher (packet fetching circuit) 701 that is, as shown in FIG. 10, configured to load vertex packets (when they are ready) from the system memory 702 (where they will have been stored following the position shading triggered by the vertex packet generator 400) into the vertex buffer 54 for use by the late primitive assembly process 33.

The packet fetcher 701 is configured to load vertex packets into the vertex buffer 54 as they are required and ready, and, correspondingly, to evict vertex packets from the vertex buffer 54 (to provide room for new vertex packets) when they are no longer required in the vertex buffer 54. When the late stage primitive assembly is to assemble primitives for a given viewpoint, the packet fetcher 701 will fetch the appropriate shaded viewpoint vertex packets for the viewpoint in question from memory, and store them in the vertex buffer 54.

To do this, as shown in FIG. 10, the packet fetcher 701 receives, inter alia, signals 703 from the vertex packet generator 400 indicating when viewpoint vertex packets have been generated and the corresponding position shading performed, such that they are ready to be loaded from the memory when required. In particular, the vertex packet generator 400 requests position shading (as discussed above) and waits until a response from the shader 47 (execution core) is received indicating that the vertex shaded viewpoint vertex packets are generated. Once all outstanding shading requests for an initial vertex packet have completed, the vertex packet generator sends a “packet ready” signal 703 to the packet fetcher.

The packet fetcher 701 also receives appropriate vertex packet evict signals 704 from a visible vertex packet generator stage/circuit 705 as shown in FIG. 10, indicative of when a vertex packet is no longer required in the vertex buffer 54 and so can be evicted from the vertex buffer 54.

The vertex packet fetcher 701 is in general configured and operable to maintain a set of position shaded viewpoint vertex packets for a particular viewpoint being processed in the vertex buffer 54 such that the required transformed positions for assembled primitives to be processed for that viewpoint will be expected to be present in the vertex buffer 54 when the primitives fall to be processed by the late primitive assembly stage 33. As discussed above, the primitive FIFO 700 assists in this by, in effect, delaying the provision of the assembled primitives to the late primitive assembly 33, to thereby allow the necessary vertex position shading to be performed, and the so-generated shaded viewpoint vertex packet to be loaded into the vertex buffer 54 before a primitive that requires vertices in a vertex packet will be received and processed by the late primitive assembly stage 33.

As shown in FIG. 10, the tiling process first comprises a culling and bounding box generator stage/circuit 61, which is followed by a visible vertex packet generator 705, which is then followed by a binner and iterator stage/circuit 62. There is then a primitive (polygon) list writing circuit 63, that writes the primitives to primitive lists, e.g. in memory, for future use.

The culling and bounding box generator 61 generates appropriate bounding boxes for the assembled primitives output by the late primitive assembly stage/circuit 33, and also operates to identify any primitives that can be culled from further processing on the basis of their (potential) visibility. This culling may comprise, for example, front/back-face culling, frustum culling, and/or sample aware culling, etc.

The bounding box generation uses the provided positions for the assembled primitives (for the viewpoint in question) to generate appropriate bounding boxes for the primitives. In the present embodiment, bounding boxes at the resolution of the individual tiles that the output is divided into for rendering purposes are used, but other arrangements would, of course, be possible.

The culling process determines whether a primitive is (potentially) visible or not. For any primitive that is determined not to be potentially visible, the primitive is culled, but otherwise the primitive is retained and passed on for processing.

The output from the culling and bounding box generation comprises for each primitive for the viewpoint in question an identifier for the primitive, a set of vertex indices for the primitive, and bounding box information for the primitive (in the present case in the form of which rendering tile or tiles the primitive falls within).

The primitives with their bounding boxes are then passed to a visible viewpoint vertex packet generator 705 that stores in memory vertex packets containing both transformed positions and vertex shaded other (non-position) attributes for vertices of primitives that have passed (and based on the vertices of primitives that have passed) the culling stage 61 (so that that data is available for use for later stages of the graphics processing, outside of the tiling process) for the viewpoint in question. When a primitive is visible, the visible viewpoint vertex packet generator checks if the vertices are already added to a packet. If it's in a packet, it will replace the vertex ID with an internal ID, which is used when accessing the data for the vertex. If it's not in a packet, the visible viewpoint vertex packet generator allocates storage for the vertex in a packet and generates an internal ID for accessing that vertex. It will then signal back to the vertex buffer, which will write the position to the proper location in the packet. It will also issue a varying shading request, where the output of the shading is written directly to the packet.

Thus, as shown in FIG. 10, the visible viewpoint vertex packet generator 705 triggers vertex attribute processing (vertex shading) 706 for any remaining (non-position) attributes of vertices belonging to primitives that have passed the culling process.

Again this further vertex shading of other (non-position) vertex attributes is performed by sending appropriate requests for that processing to an appropriate vertex shading process of the graphics processor. (The vertex indices are sent from the packet generation down the pipeline to the visible viewpoint vertex packet generator to facilitate this.) As previously described for position shading, these other (non-position) shading requests are accumulated and sent in groups of 16 vertices (1warp).

The processed other (non-position) vertex attributes are then added appropriately to the generated shaded viewpoint vertex packets for the viewpoint in question, such that the shaded viewpoint vertex packets then store both the transformed positions and other (non-position) processed vertex attributes for the vertices that they relate to for the viewpoint.

As shown in FIG. 10, the visible viewpoint vertex packet generator 705 also sends appropriate vertex packet evict signals 704 to the packet fetcher 701 to indicate when position shaded viewpoint vertex packets may be (safely) evicted from the vertex buffer 54. (Once the last primitive using vertices from the oldest packet has been processed, and the position data written from the vertex buffer to the vertex packet in memory, the packet can be evicted.)

To facilitate this operation, the vertex packet generation process includes with the sequence of assembled primitives an indication of when no more assembled primitives will use a particular (initial or viewpoint) vertex packet (after all the assembled primitives that will use a vertex packet have been included in the sequence of assembled primitives). In the embodiment shown in FIG. 10, this indication is provided by the vertex packet generator 400 when a vertex packet is evicted from the vertex packet “queue” as the vertex packets are being assembled and sent for vertex shading (i.e. at step 507 in FIG. 5). In this embodiment, the indication can comprise an indicator of the packet index (as described with relation to FIGS. 4 and 4) for the vertex packet (as will be appreciated, the viewpoint vertex packets also comprise the same index as the initial vertex packet used to generate them, and so can be referred to by way of the packet index).

When the visible vertex packet generator sees the indication that no more assembled primitives will use a given shaded viewpoint vertex packet, then it can determine that all assembled primitives that will use a particular shaded viewpoint vertex packet have passed the late primitive assembly, and in particular the culling and bounding box generation, stages, such that there will be no more primitives that will require that viewpoint vertex packet from the vertex buffer. It accordingly then sends a vertex packet evict signal 704 to the packet fetcher 701, to indicate that the vertex packet in question can be safely evicted from the vertex buffer 54.

The primitives with their bounding boxes for the viewpoint are then passed to the binning iterator stage/circuit 62, which operates to identify using the bounding boxes for the primitives which primitive lists the primitives should be listed in (by comparing the bounding boxes for the primitives with the respective primitive list regions), and outputs the respective primitives and their target primitive list(s) (bin(s)) for the viewpoint in question.

The primitive (polygon) list writing stage/circuit 63 then writes 707 the primitives into the respective primitive (polygon) lists for the viewpoint in memory. As shown in FIG. 10, the primitive lists may be compressed before being written to memory.

As will be appreciated, the primitive list writing stage is one such example for preparing primitive lists for a given viewpoint, and other arrangements are possible.

For instance, in some embodiments, other arrangements for allowing primitives to be processed for a rendering tile to be identified, such as the use of hierarchies of bounding boxes for primitives, are used.

The above described processing in FIG. 10 up to and including the preparation and writing of the primitive lists 707 can be considered to be a sequence of appropriate geometry processing (geometry stages) of the overall graphics processing sequence and graphics processing pipeline that is executed when generating an output.

As will be appreciated, there will then be subsequent processing stages that are performed once the primitive lists for a given viewpoint have been prepared (and that can correspondingly be considered to be a sequence of fragment processing stages (fragment stages) that are performed when generating an output).

As the present embodiments use tile-based rendering, these fragment stages will be performed for respective tiles for a given viewpoint of the output being generated separately.

These “fragment stages” may, for example, and in an embodiment, start with a primitive (polygon) list reader stage/circuit reading the primitive list or lists for a viewpoint applying to the tile that is being processed and outputting (providing to the subsequent processing stage) a sequence of primitives to be processed for the tile for the viewpoint in question.

There may then be a vertex fetcher stage that is operable to fetch vertex attributes, and in particular the appropriately vertex shaded positions, for the primitives for the viewpoint in question provided by the primitive list reader for the tile being processed.

The sequence of primitives for the viewpoint may then be provided to a triangle (primitive) setup stage/circuit that performs any required primitive (triangle) setup processing, such as deriving line equations for the edges of the primitives.

Once primitive (triangle) setup has been performed for a primitive, the primitive may be provided to a rasteriser for rasterisation into graphics fragments, which fragments are then provided to appropriate rendering (fragment processing) stages/circuits of the pipeline. The rendering (fragment processing) that is performed can comprise any suitable and desired rendering (fragment processing) that may be performed for a graphics processing pipeline. It in an embodiment comprises at least performing fragment shading of the fragments.

The rasteriser and rendering (fragment processing) can be performed in any suitable and desired manner, such as, and in an embodiment, in the normal manner for the graphics processor and graphics processing pipeline in question.

Although the above described generating rendered data using rasterisation, other processes for generating rendered data for a viewpoint can be used as appropriate.

For instance, in some embodiments, other rendering processes, such as ray-tracing, and/or hybrid ray-tracing, are also or instead used to generate rendered fragment data for a viewpoint.

The rendered fragment data for the viewpoint is then appropriately output to memory, from where it may then be used for the viewpoint, e.g. for display or other purposes. (The processed fragment data will be written out to memory via an appropriate tile buffer, as the graphics processor and pipeline performs tile based graphics processing.)

It should be noted here that although the Figures only show a few primitives, vertices, indices, positions, etc., for clarity purposes, the number of primitives, vertices, indices, for a given output may be, and typically will be, significantly higher.

As will be appreciated by those skilled in the art, the technology described herein, in its embodiments at least, can provide a more efficient graphics processing pipeline, in particular with respect to the processing and handling of vertex attributes for primitives being processed when performing multi-view rendering. This is achieved, in the embodiments of the technology described herein at least, by generating initial vertex packets based on vertices for assembled primitives, and then generating vertex packets for each viewpoint being rendered using those initial vertex packets.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

What is claimed is:

1. A method of operating a graphics processor that executes a graphics processing pipeline to generate an output, the graphics processing pipeline being executed comprising:
a sequence of one or more geometry processing stages to perform geometry processing, one or more of the sequence of one or more geometry processing stages generating vertex packets for subsequent processing, the vertex packets comprising vertices for assembled primitives; and
a rendering stage for rendering an output being generated;
the method comprising:
when executing the graphics processing pipeline to render a scene from a plurality of viewpoints:
performing at least some of the geometry processing stages of the sequence of one or more geometry processing stages of the graphics processing pipeline to generate an initial vertex packet comprising vertices for assembled primitives for the scene being rendered; and
generating, for each viewpoint of the plurality of viewpoints, a respective viewpoint vertex packet using the initial vertex packet; and
providing the viewpoint vertex packets generated for the plurality of viewpoints to a further stage or stages of the graphics processing pipeline being executed for rendering the scene from the plurality of viewpoints.

2. The method of claim 1, wherein the initial vertex packet is generated by allocating vertices for assembled primitives to a vertex packet until the vertex packet reaches a threshold capacity.

3. The method of claim 2, wherein the vertices are allocated from a sequence of vertices for assembled primitives.

4. The method of claim 2, wherein a primitive assembly stage of the one or more geometry processing stages generates a sequence of assembled primitives using a set of vertices to be used for primitives to be processed when generating the output, each vertex having associated with it a set of one or more vertex attributes, together with a set of vertex indices referencing vertices in the set of vertices and primitive configuration information indicating how the vertex indices are to be assembled into primitives for processing when generating the output provided to the graphics processing pipeline,
the sequence of assembled primitives comprising a sequence of vertices for assembled primitives.

5. The method of claim 1, wherein generating, for each viewpoint of the plurality of viewpoints, a respective viewpoint vertex packet using an initial vertex packet comprises:
sending the initial vertex packet for vertex attribute processing a plurality of times corresponding to the number of viewpoints of the plurality of viewpoints.

6. The method of claim 5, wherein each time the initial vertex packet is sent for the vertex attribute processing the initial vertex packet sent for the vertex attribute processing is associated with a particular one of the viewpoints.

7. The method of claim 5, further comprising
performing the vertex attribute processing on the initial vertex packet based on which viewpoint the packet is for.

8. The method of claim 1, wherein, generating, for each viewpoint of the plurality of viewpoints, a respective viewpoint vertex packet using an initial vertex packet comprises:
duplicating the initial vertex packet into a number of vertex packets to give a set of vertex packets corresponding to the number of viewpoints in the plurality of viewpoints, and associating each of those vertex packets with a particular one of the viewpoints; and
performing vertex attribute processing for the vertex packets of the set of vertex packets based on which viewpoints the vertex packets are for.

9. The method of claim 1, wherein each respective viewpoint vertex packet is associated with a viewpoint identifier that identifies which of the plurality of viewpoints the respective viewpoint vertex packet is for.

10. A graphics processor operable to execute a graphics processing pipeline to generate an output, the graphics processor comprising processing circuits configured to execute a processing pipeline comprising:
a sequence of one or more geometry processing stages to perform geometry processing, one or more of the sequence of one or more geometry processing stages configured to generate vertex packets for subsequent processing, the vertex packets comprising vertices for assembled primitives; and
a rendering stage for rendering an output being generated;
the graphics processor further comprising:
a processing circuit configured to, when the graphics processor is executing the graphics processing pipeline to render a scene from a plurality of viewpoints:
generate, using an initial vertex packet generated by performing at least some of the geometry processing stages of the sequence of one or more geometry processing stages of the graphics processing pipeline and comprising vertices for assembled primitives for the scene being rendered, a respective viewpoint vertex packet for each viewpoint of the plurality of viewpoints; and
provide the viewpoint vertex packets generated for the plurality of viewpoints to a further stage or stages of the graphics processing pipeline being executed for rendering the scene from the plurality of viewpoints.

11. The graphics processor of claim 10, wherein the one or more of the sequence of one or more geometry processing stages configured to generate vertex packets for subsequent processing are configured to generate vertex packets by:
allocating vertices for assembled primitives to a vertex packet until the vertex packet reaches a threshold capacity.

12. The graphics processor of claim 11, wherein the vertices are allocated from a sequence of vertices for assembled primitives.

13. The graphics processor of claim 11, wherein the one or more geometry processing stages comprise a primitive assembly stage configured to:
generate a sequence of assembled primitives using a set of vertices to be used for primitives to be processed when generating the output, each vertex having associated with it a set of one or more vertex attributes, together with a set of vertex indices referencing vertices in the set of vertices and primitive configuration information indicating how the vertex indices are to be assembled into primitives for processing when generating the output provided to the graphics processing pipeline,
wherein the sequence of assembled primitives comprises a sequence of vertices for assembled primitives.

14. The graphics processor of claim 10, wherein the processing circuit is configured to, when using an initial vertex packet to generate a respective viewpoint vertex packet for each viewpoint of the plurality of viewpoints:
send the initial vertex packet for vertex attribute processing a plurality of times corresponding to the number of viewpoints of the plurality of viewpoints.

15. The graphics processor of claim 14, wherein the processing circuit is further configured to:
each time the initial vertex packet is sent for vertex attribute processing, associate the initial vertex packet sent for vertex attribute processing with a particular one of the viewpoints.

16. The graphics processor of claim 10, wherein the graphics processing pipeline further comprises a vertex attribute processing stage configured to perform vertex attribute processing, and wherein
the vertex attribute processing stage is further configured to perform vertex attribute processing for an initial vertex packet received by the vertex attribute processing stage based on which viewpoint the initial viewpoint vertex packet is for.

17. The graphics processor of claim 10, wherein:
the graphics processing pipeline further comprises a vertex attribute processing stage configured to perform vertex attribute processing; wherein the processing circuit is further configured to, when using an initial vertex packet to generate a respective viewpoint vertex packet for each viewpoint of the plurality of viewpoints:
duplicate the initial vertex packet into a number of vertex packets to give a set of vertex packets corresponding to the number of viewpoints in the plurality of viewpoints, and associate each of those vertex packets with a particular one of the viewpoints; and wherein
the vertex attribute processing stage is further configured to perform vertex attribute processing for the vertex packets of the set of vertex packets based on which viewpoints the vertex packets are for.

18. The graphics processor of claim 12, wherein the processing circuit is configured to:
associate each respective viewpoint vertex packet with a viewpoint identifier that identifies which of the plurality of viewpoints the respective viewpoint vertex packet is for.

19. A non-transitory computer readable storage medium storing software code which when executing on one or more processors performs a method of operating a graphics processor that executes a graphics processing pipeline to generate an output, the graphics processing pipeline being executed comprising:
a sequence of one or more geometry processing stages to perform geometry processing, one or more of the sequence of one or more geometry processing stages generating vertex packets for subsequent processing, the vertex packets comprising vertices for assembled primitives; and
a rendering stage for rendering an output being generated;
the method comprising:
when executing the graphics processing pipeline to render a scene from a plurality of viewpoints:
performing at least some of the geometry processing stages of the sequence of one or more geometry processing stages of the graphics processing pipeline to generate an initial vertex packet comprising vertices for assembled primitives for the scene being rendered; and
generating, for each viewpoint of the plurality of viewpoints, a respective viewpoint vertex packet using the initial vertex packet; and
providing the viewpoint vertex packets generated for the plurality of viewpoints to a further stage or stages of the graphics processing pipeline being executed for rendering the scene from the plurality of viewpoints.
